(19) United States
(12) Patent Application Publication
(10) Pub. No.: US 2008/0169449 A1
(43) Pub. Date: Jul. 17, 2008

(54) CATALYTIC MEMBRANE REACTOR AND METHOD FOR PRODUCTION OF SYNTHESIS GAS

(75) Inventor: Michael V. MUNDSCHAU, Longmont, CO (US)

Correspondence Address: CONLEY ROSE, P.C.;David A. Rose, P. O. BOX 3267, HOUSTON, TX, 77253-3267, US

(73) Assignee: ELTRON RESEARCH INC., Boulder, CO (US)

(21) Appl. No.: 11/851,017

(22) Filed: Sep. 6, 2007

Related U.S. Application Data
(60) Provisional application No. 60/843,433, filed on Sep. 8, 2006.

(51) Int. Cl. C01B 3/38; C10J 3/48

(52) U.S. Cl. 252/373; 48/62 R

(57) ABSTRACT

A solid state membrane for a reforming reactor is disclosed which comprises at least one oxygen anion-conducting oxide selected from the group consisting of hexaaluminates, cerates, perovskites, and other mixed metal oxides that are able to adsorb and dissociate molecular oxygen. The membrane adsorbs and dissociates molecular oxygen into highly active atomic oxygen and allows oxygen anions to diffuse through the membrane, to provide high local concentration of oxygen to deter formation and deposition of carbon on reformer walls. Embodiments of the membrane also have catalytic activity for reforming a hydrocarbon fuel to synthesis gas. Also disclosed are a reformer having an inner wall containing the new membrane, and a process of reforming a hydrocarbon feed, such as a high sulfur-containing diesel fuel, to produce synthesis gas, suitable for use in fuel cells.

### CROSS-REFERENCE TO RELATED APPLICATIONS

This application claims the benefit under 35 U.S.C. § 119(e) of U.S. Provisional Patent Application No. 60/843,433 filed Sep. 8, 2006, the disclosure of which is hereby incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. DE-FG02-05ER84394 awarded by the U.S. Department of Energy SBIR Program.

### BACKGROUND OF THE INVENTION

1. Technical Field of the Invention

The present disclosure generally relates to methods, compositions and apparatus for reforming carbonaceous feedstocks to produce synthesis gas. More particularly, this disclosure relates to the reforming of hydrocarbon fuels using a catalytic membrane reactor having walls that are catalytic and provide enhanced local concentration of oxygen to the reactor, especially to the inner walls of the reactor. Still more particularly, the disclosure relates to such compositions when used to line the reactor's inner walls to establish a high oxygen concentration near the inner walls and deter carbon buildup on inner reactor walls.

2. Background of the Invention

It is highly desirable throughout the world today to convert carbonaceous feedstocks, particularly the hydrocarbons of commercial diesel fuel, into a mixture of hydrogen (H₂) and carbon monoxide (CO), known as synthesis gas. As its name implies, synthesis gas is useful for producing a number of synthetic fuels, which will be essential for replacing dwindling supplies of petroleum and natural gas. The synthesis gas itself can be used as a fuel in solid oxide fuel cells, or the hydrogen may be used in pollution control devices for diesel vehicles.

A major impediment to the commercialization of solid oxide fuel cell systems for the automotive market is the lack of efficient, low-cost, compact reformers for carrying out the conversion of diesel fuel to synthesis gas. Hitherto, it has proven difficult to reform commercial diesel fuel into synthesis gas in small compact fuel reformers without greatly dropping overall system efficiency by use of excess steam, hydrogen or oxygen to suppress formation of carbon. Thermodynamics dictates that the desired H₂ and CO molar ratios are overwhelmingly favored if the fuel is reformed above about 1000° C., but few catalysts can operate at such temperatures.

Thermodynamics also indicates that elemental carbon is overwhelmingly favored at lower temperatures, resulting in deposition of massive quantities of carbon onto reactor walls in the cooler zones of the reactor as diesel fuel is heated from ambient temperatures to the desired reforming temperature. Deposition of carbon is especially problematic in the range 300-800° C. where reaction kinetics favors rapid cracking of fuel into carbon. Deposited carbon will completely plug reactors if proper precautions are not taken. A key issue in the design of a diesel fuel reformer is the prevention of the formation of elemental carbon. If conditions are thermodynamically and kinetically favorable for the formation of graphite, carbon will readily deposit onto reactor walls and onto reformer catalysts, rapidly poisoning catalysts and plugging reactors. Moreover, graphite is autocatalytic for its own formation. Graphite, once nucleated, acts as a catalyst for its own growth. This implies that once graphite forms, deposition will continue exponentially if thermodynamics and kinetics are favorable. Understanding the thermodynamic conditions which disfavor the formation of graphite is critical to good reactor design and to the establishment of practical reformer operating conditions. Formation of carbon is conventionally suppressed by addition of steam, CO₂, hydrogen, or excess oxygen. However, those options lead to reduction of overall fuel cell system efficiencies.

A second major issue in reforming diesel fuel is the poisoning of most common reforming catalysts (e.g., those based upon nickel) by sulfur which is present in relatively large quantities in automotive fuels. It has proven difficult to reform fuel containing high levels of sulfur (>100 ppm by mass) because of poisoning of catalysts. Analysis of commercial D-2 type diesel fuel (in July, 2005) found <500 ppm sulfur (by mass). Legislation in many states now requires reduction of sulfur to <15 ppm (by mass). Today the military fuel, JP-8, and jet fuels may contain 3000-10,000 parts per million (by mass) sulfur (0.3% to 1.0% by mass of sulfur). Typically, reforming catalysts must be chosen and operated under conditions which prevent formation of bulk sulfides. Understanding of the thermodynamics of sulfide formation is essential for the proper design and selection of reforming catalysts.

A third major issue in the reforming of diesel fuel involves the relative difficulty of oxidizing polycyclic aromatic compounds in diesel fuels. A few representative polycyclic aromatic compounds which are exceptionally stable and difficult to reform are naphthalene (C₁₀H₈), anthracene (C₁₄H₁₀), phenanthrene (C₁₄H₁₀), pyrene (C₁₅H₁₀) and benzo[α]pyrene (C₂₀H₁₂). Polycyclic aromatic compounds, upon loss of hydrogen, are transformed into graphite and act as nuclei for formation of soot. The aromatic compounds are especially stable and typically require atomic oxygen (or an activated or other dissociated form of oxygen) for their oxidation. Heating molecular oxygen to elevated temperature (>1000° C.) dissociates only a very small fraction of the molecules into atomic oxygen. More typically, catalysts are used which adsorb and dissociate molecular oxygen, forming mobile atomic oxygen on the catalyst surface.

Commercial type D-2 diesel fuel typically contains over 400 distinct types of organic compound. According to G. A. Olah and Á. Molnár,¹ the majority of hydrocarbons in diesel fuel range in size from about 15 carbon atoms per molecule to about 25 carbon atoms per molecule (C₁₅-C₂₅). J. W. Wigger and B. E. Torkelson² compared the relative distribution of the number of carbon atoms per molecule in diesel fuel, JP-8, kerosene, and a typical crude oil.

Diesel fuels are mixtures of organic compounds and typically contain about 80 volume percent alkane molecules and 20 volume percent aromatic molecules. The latter include polycyclic aromatic compounds such as anthracene, naphthacene and pentacene. These molecules contain three, four and five, fused benzene rings, respectively. Methylated, ethylated and higher alkylated derivatives of naphthalene and the other polycyclic aromatic compounds are also present in diesel fuel. The multiple aromatic ring structures in the polycyclic aromatic hydrocarbons possess considerable stabilization through resonance (see, e.g., T. W. Graham Solomons³) and, thus, the polycyclic aromatic compounds are much more difficult to reform relative to alkanes. Moreover, under high temperature conditions in fuel reformers, some of the long-chain alkanes can crack and be converted into more stable aromatic compounds, such as naphthalene. In addition to the large fraction of polycyclic aromatic compounds, commercial diesel fuels typically contain over twenty distinct varieties of organic molecule containing sulfur (Wigger and Torkelson²). The sulfur compounds include heterocyclic aromatic compounds. Sulfur poisons many common reforming catalysts, in particular, those based upon elemental nickel.

Still another issue in the reforming of diesel fuel is that all reactor components and catalysts must remain thermally and chemically stable under the elevated temperatures and harsh chemical environments that are typically required for reforming of diesel fuel. This places severe constraints on the type of catalyst and reactor wall material that can be employed in the diesel fuel reformers.

U.S. Pat. No. 6,998,096 (Ishikawa) describes a fuel reformer for polymer electrolyte fuel cells which comprises a burner; a reforming portion surrounding the burner, having an exhaust port, and exhausting a reformed gas from the exhaust port; and a heat exchanger having a higher temperature side, the higher temperature side being connected directly with the exhaust port of the reforming portion, the heat exchanger establishing heat exchange between the reformed gas and a raw material gas.

U.S. Pat. No. 6,936,567 (Ueda et al) describes a fuel reformer for reforming a hydrocarbon base fuel into a hydrogen rich gas and a method of manufacturing hydrogen rich gas. The fuel reformer comprises a Cr oxide layer formed on at least a part of the surface of steel material. It is said that the reformer produces no red scale through water vapor oxidation of the surface of the steel material from which the reformer is made, even when exposed to an atmosphere of low oxygen concentration and/or high water vapor concentration under a high temperature.

U.S. Pat. No. 6,921,596 (Kelly et al.) describes a solid-oxide fuel cell system including an integrated reforming unit comprising a hydrocarbon fuel reformer; an integral tail gas and cathode air combustor and reformer heat exchanger; a fuel pre-heater and fuel injector cooler; a fuel injector and fuel/air mixer and vaporizer; a reforming air pre-heating heat exchanger; a reforming air temperature control valve and means; and a pre-reformer start-up combustor. The integration of a plate reformer, tail gas combustor, and combustor gas heat exchanger allows for efficient operation modes of the reformer, both endothermic and exothermic as desired. The combustor gas heat exchanger aids in temperature regulation of the reformer and reduces significant thermal gradients in the unit.

U.S. Pat. No. 6,632,409 (Kuwaba) describes a reformer for a fuel cell, which includes an evaporation portion for evaporating a raw material, a reforming portion for producing a reformed gas whose principal element is hydrogen from the raw materials, a CO reduction portion for reducing CO involved in the reformed gas, a circulating conduit portion having a storage tank for storing the raw material, a feeding device for feeding the raw material under pressure, a cooling device for cooling the CO reduction portion and a supply device for supplying the raw material to the evaporation portion. The supply device includes a conduit branched from the circulating conduit portion connected to the evaporation portion and a flow control device provided in the conduit.

None of the existing reformer systems are capable of operating effectively at the efficiencies required for converting commercial diesel fuel into a mixture of H₂ and CO for practical use in solid oxide fuel cells. Despite the advances that have been made in the art, there remains a substantial need for other and better apparatus and more efficient materials and methods for the production of synthesis gas, to address the major issues of cost, carbon deposition in the cooler zones of the reformer, and catalyst intolerance to sulfur. Desirable fuel reformer catalysts should be capable of operating at temperatures up to 1000° C., of handling at least 15 ppmv sulfur in a diesel fuel feedstock, and should be able to provide stable, long term operation for more than 5,000 hours. It is also desirable for catalytic diesel fuel reformers to operate with minimum use of water for suppression of the deposition of carbon.

Technology for converting highly sulfur-contaminated liquid fuels into synthesis gas would find widespread application for reforming the military fuel, JP-8, into H₂+CO as a fuel for solid oxide fuel cells used to provide electric power for various devices. New reformer technologies are also in high demand by the petroleum industry for reforming high sulfur, bottom-of-the-barrel petroleum reserves into synthesis gas. The synthesis gas, upon removal of H₂S by well established industrial methods, could be used to mass produce low-sulfur synthetic diesel fuel, methanol, synthetic natural gas, hydrogen, and other alternative fuels. In addition to producing H₂+CO for automotive fuel cells, reformers with improved technology could find application for providing syngas for automotive gas turbine engines that run on the same gaseous fuel as solid oxide fuel cells. Accordingly, there is continuing interest in developing efficient ways to produce synthesis gas.

### SUMMARY OF THE INVENTION

Various embodiments of the present invention provide processes, compositions and apparatus which are useful for converting carbonaceous materials, especially sulfur-containing liquid diesel fuel and the military logistic fuel, JP-8, into a mixture of synthesis gas (H₂ and CO). Accordingly, certain embodiments of the invention provide a catalytic reformer for producing synthesis gas from a hydrocarbon fuel which comprise (a) a first vessel comprising an air inlet, a reactor outer wall, an annular space and an air exhaust outlet; and (b) a second vessel located in the annular space and including: (i) a cool zone comprising a fuel inlet, (ii) a hot zone in fluid communication with the cool zone and comprising a synthesis gas outlet and a reforming catalyst, and (iii) a reactor inner wall surrounding the cool and hot zones and including a membrane comprising at least one metal oxide that transfers oxygen from the annular space through the inner wall and effuses active oxygen into at least one of the cool zone and the hot zone when the reformer is operated to produce synthesis gas. For the purposes of this disclosure, the term “active oxygen” refers to oxygen species that are active for reacting with a hydrocarbon fuel in the presence of a reforming catalyst. Active oxygen species include, but are not limited to, atomic oxygen, oxygen anions (O²⁻), and molecular oxygen.

In some embodiments, the first vessel further comprises an exhaust zone configured for receiving reacted gases from the hot zone. In some embodiments, the membrane, or a section thereof, further comprises a carbon suppression catalyst that converts carbon to one or more carbon oxides to suppress carbon deposition on the inner wall when the reformer is operated to produce synthesis gas.

In some embodiments, the reforming catalyst in the hot zone comprises: at least one metal selected from the group consisting of Pt, Rh, Ir, W, Mo, Co, Fe, and alloys thereof, or a metal oxide selected from the group consisting of hexaaluminates, cerates and perovskites. In some embodiments, the reforming catalyst in the hot zone comprises a metal oxide, and the membrane, or a section thereof, comprises a metal oxide that is the same or different than the reforming catalyst. For example, at least one of the reforming catalyst and the membrane may comprise at least one metal oxide having the formula: La₁₋ₓAₓBO_{3-δ}, wherein A=Ca²⁺ or Sr²⁺, B=Co, Mn, or Fe, wherein x is greater than 0 and less than 1 (0<x<1), and δ is the number of oxygen vacancies in the resulting oxide crystal lattice. In some embodiments the metal oxide is disposed on a refractory support.

In some embodiments at least one said metal oxide has the formula La₁₋ₓSrₓFeO_{3-δ}, wherein x is greater than 0 and less than 1 (0<x<1) and δ is the number of oxygen vacancies in the metal oxide crystal lattice, said metal oxide being disposed on a refractory support.

In some embodiments the membrane, or a section thereof, comprises La₁₋ₓCaₓFeO_{3-δ} (or variations of this perovskite material, wherein some or all of the Ca is replaced by Sr or Ba and some or all Fe is replaced by Co and/or Mn or other catalytic metals), optionally deposited on a ceramic support, and the reforming catalyst comprises La₁₋ₓCaₓFeO_{3-δ} or Pt—Rh wire gauze. In some embodiments the refractory support comprises yttria stabilized zirconia.

Also provided in accordance with certain embodiments is a reforming process for production of synthesis gas, which comprises (a) providing a catalytic fuel reformer comprising (i) a first vessel comprising an air inlet, a reactor outer wall, an annular space and an air exhaust outlet; and (ii) a second vessel located in the annular space and including (1) a cool zone comprising a fuel inlet, (2) a hot zone in fluid communication with the cool zone and comprising a reforming catalyst and a synthesis gas outlet, and (iii) a reactor inner wall surrounding the cool and hot zones and comprising a membrane containing at least one metal oxide that transfers oxygen from the annular space through the inner wall and effuses active oxygen into the cool zone and the hot zone. The process includes (b) heating the cool zone to a temperature in the range of about 300-900° C.; (c) heating the hot zone to a temperature above about 900° C.; (d) passing an oxygen-containing gas into the air inlet, whereby active oxygen effuses from the membrane into the cool zone and the hot zone; and (e) passing a hydrocarbon fuel into the fuel inlet, through the cool zone into the hot zone, whereby the hydrocarbon fuel, in contact with the reforming catalyst, reacts with the active oxygen to form synthesis gas.

In some embodiments (d) comprises effusing sufficient active oxygen from the membrane to the inner wall to maintain the active oxygen level along the inner wall sufficiently high to suppress deposition of carbon on the inner wall. In some embodiments the membrane effuses sufficient active oxygen into the hot zone to maintain a carbon-to-oxygen atomic ratio of about 1:1 along the inner wall. In some embodiments CO₂ is added to the hydrocarbon feed. The process of claim 10, wherein the membrane, or a section thereof, further comprises a carbon suppression catalyst that converts carbon to one or more carbon oxides to suppress carbon deposition on the inner wall when the reformer operate to produce synthesis gas.

In some embodiments the reforming catalyst in the hot zone comprises: at least one metal selected from the group consisting of Pt, Rh, Ir, W, Mo, Mn, Co, Fe, and alloys thereof, or a metal oxide selected from the group consisting of hexaaluminates, cerates and perovskites. In some embodiments the membrane, or a section thereof, further comprises a carbon suppression catalyst which is the same or different than the reforming catalyst. In some embodiments the reforming catalyst in the hot zone comprises a metal oxide, and the membrane, or a section thereof, comprises a metal oxide that is the same or different than the reforming catalyst.

In some embodiments at least one of the reforming catalyst and the membrane comprises: (i) at least one metal oxide having the formula: La₁₋ₓAₓBO_{3-δ}, wherein A=Ca²⁺ or Sr²⁺, B=Co, Mn, or Fe, wherein x is greater than 0 and less than 1 (0<x<1), and δ is the number of oxygen vacancies in the resulting oxide crystal lattice. In some embodiments the metal oxide is disposed on a refractory support.

In some embodiments at least one said metal oxide has the formula La₁₋ₓSrₓFeO_{3-δ}, wherein x is greater than 0 and less than 1 and δ is the number of oxygen vacancies in the metal oxide crystal lattice, said metal oxide being disposed on a refractory support. In some embodiments the membrane, or a portion thereof, comprises La₁₋ₓCaₓFeO_{3-δ}, or variations of that perovskite, wherein some or all of the Ca is replaced by Sr or Ba and some or all Fe is replaced by Co and/or Mn or other catalytic metals) optionally deposited on a ceramic support, and the reforming catalyst comprises La₁₋ₓCaₓFeO_{3-δ} or Pt—Rh wire gauze. In some embodiments the refractory support comprises yttria stabilized zirconia.

Still further provided in accordance with certain embodiments of the invention is an oxygen transport membrane for a fuel reforming reactor, comprising: a structure having an inner surface; an outer surface; and a metal oxide material selected from the group consisting of hexaaluminates, cerates and perovskites, wherein the metal oxide material transports oxygen from the outer surface and effuses active oxygen at the inner surface, when an oxygen containing gas is passed over the outer surface. In some embodiments a carbon suppression catalyst is deposited on the inner surface, wherein the carbon suppression catalyst converts carbon to carbon oxides in the presence of active oxygen.

In some embodiments the metal oxide has the formula La₁₋ₓAₓBO_{3-δ}, wherein A=Ca²⁺ or Sr²⁺, B=Co, Mn, or Fe, x is greater than 0 and less than 1, and δ is the number of oxygen vacancies in the metal oxide crystal lattice. In some embodiments the membrane comprises a first section configured for surrounding a <900° C. zone in a fuel reforming reactor and a second section configured for surrounding a >900° C. zone in the reactor, wherein the first section provides a higher oxygen flux than the second section, when an oxygen containing gas is passed over the outer surface. These and other embodiments, features and advantages of the present invention will become apparent with reference to the following description and drawings.

### BRIEF DESCRIPTION OF THE DRAWINGS

FIG. 1 is a schematic illustration of a catalytic reformer in accordance with an embodiment of the present invention.

FIG. 2 is a graph showing the thermodynamic equilibrium calculations for reforming diesel fuel into synthesis gas, to determine equilibrium conditions which favor formation of desired H₂ and CO while avoiding deposition of elemental carbon.

FIG. 3 is a graph summarizing the relative catalyst activity (% reformed diesel per time) of various unsupported perovskite catalyst beds for diesel fuel reforming and a supported Pt—Rh/YSZ catalyst tested at 1000° C.

FIG. 4 is a graph summarizing the hydrogen production rate of representative unsupported perovskite catalyst beds tested at 1000° C. with steam to carbon molar ratio of 4 and an atomic oxygen to carbon ratio of 0.46.

FIG. 5 is a graph summarizing carbon monoxide production rate of representative unsupported perovskite catalyst beds tested as described for FIG. 4.

FIG. 6 is a graph summarizing relative catalyst activity for diesel fuel reforming of representative perovskite catalysts supported on yttria-stabilized zirconia tested as described in FIG. 4.

FIG. 7 is a graph summarizing hydrogen production rate of representative perovskite catalysts supported on yttria-stabilized zirconia tested as described in FIG. 4.

FIG. 8 is a graph summarizing carbon monoxide production rate of representative perovskite catalysts supported on yttria-stabilized zirconia tested as described in FIG. 4.

FIG. 9 is a graph of powder X-ray diffraction data from a La₁₋ₓSrₓFeO_{3-δ} catalyst after 200 hours continuous operation under diesel fuel reforming conditions at 1000° C., showing stability and structure retention of the perovskite crystal structure.

FIG. 10 is a graph showing long-term (two month) diesel reforming activity of representative catalyst formulations tested at 1000° C. under commercial diesel fuel reforming conditions, compared to other catalysts.

FIG. 11 illustrates the local atomic ratio of oxygen-to-carbon that is needed at the reactor walls to completely suppress formation of carbon.

### DETAILED DESCRIPTION OF THE PREFERRED EMBODIMENTS

### Introduction

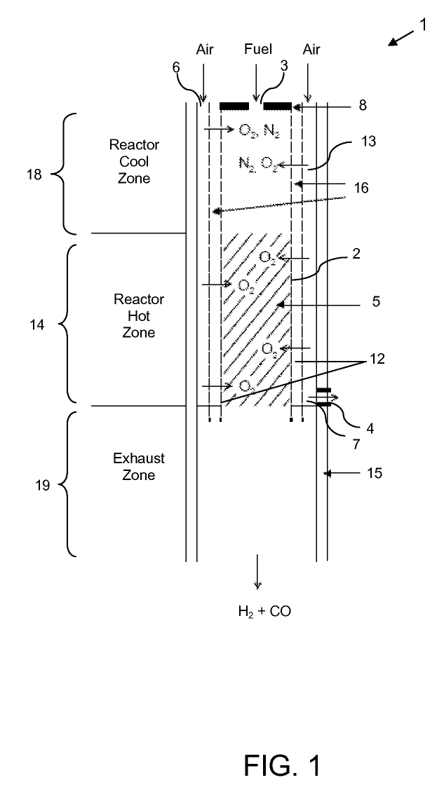

Referring to FIG. 1, a conceptual illustration of an embodiment of a new catalytic reformer 1 is shown in which an oxygen transport membrane material is integrated with a sulfur-tolerant reforming catalyst. The membrane is based upon oxygen transport ceramic materials and serves as a self-cleaning ceramic wall 2 for reformer 1. “Self-cleaning” refers to the ability of the wall material to avoid and/or eliminate deposition of carbon on the reactor walls. The reactor 1 comprises a porous wall 2 comprising selected metal oxides which readily adsorb and dissociate molecular oxygen. The reactor wall transports oxygen from the air side of the membrane to the fuel side. The wall may be formed by pressing and sintering the metal oxide precursor materials. Additionally, in various embodiments, the membrane contains a catalyst that converts carbon to carbon oxides, and/or may contain a catalyst with reforming activity. For example, the metal oxides of the membrane may have both oxygen transporting activity and catalytic activity. In the embodiment shown in FIG. 1, a denser oxygen transport membrane material makes up wall portion 12 surrounding the reactor hot zone 14, which is configured for containing a reforming catalyst (e.g., a catalyst bed or wire gauze). A comparatively less dense oxygen transport membrane material makes up wall portion 16 surrounding cool zone 18.

Outer wall 15 defines a tubular or cylindrical vessel having an annular space 13 in which a second vessel comprising a tubular or cylindrical inner wall 2 of the reformer is disposed. Annular space 13 comprises an air inlet 6, an outlet 4 for exhausting N₂-enriched air, and a boundary 7 between the hot zone 14 and an exhaust zone 19. Exhaust zone 19 is in fluid communication with hot zone 14 for receiving produced syngas. A portion 16 of inner wall 2 surrounds a cool zone 18, and comprises porous catalytic material/oxygen transport material that is capable of transporting oxygen into the cool zone 18 of the diesel fuel reformer 1. Cool zone 18 has a fuel inlet 3 and a radiation shield 8, and is followed by hot zone 14. Reactor hot zone 14 is surrounded by portion 12 of inner wall 2, and contains the reforming catalyst 5. Portion 12 comprises comparatively denser materials than that of portion 16, and serves to restrict flow of nitrogen into the reformer via wall 12 while effusing at least some O₂ into the hot zone. In alternative embodiments, the membrane that makes up wall 2 may be of uniform density. The composition and properties of the inner wall 2 are discussed in more detail in sections which follow.

Embodiments of the new reformer are preferably compact, inexpensive to make, capable of stable operation, and capable of using commercial grade diesel fuel as a feedstock and preventing carbon build-up by transport of oxygen through self-cleaning reformer walls. When the reformer is employed for producing synthesis gas from diesel fuel, high oxygen flux through the membrane to the inner reactor wall reacts with and removes any carbon which may temporarily form, as described in more detail below. The porous catalytic membrane reactor wall 2 is essentially a self-cleaning system, effectively suppressing deposition of carbon. The reactor inner wall is preferably fabricated from refractory oxides that are selected, as described below, for maximum oxygen transport and maximum carbon oxidation activity, while retaining stability and activity at 1000° C. and above. Porous catalytic membrane reactor walls rather than dense walls are chosen in the design of certain embodiments of the reactor in order to deliver the relatively large quantities of air required for a 5000 W fuel reformer, for example, while maintaining a compact reformer size.

### I. Calculation of Favorable Thermodynamic Conditions for Reforming Diesel Fuel.

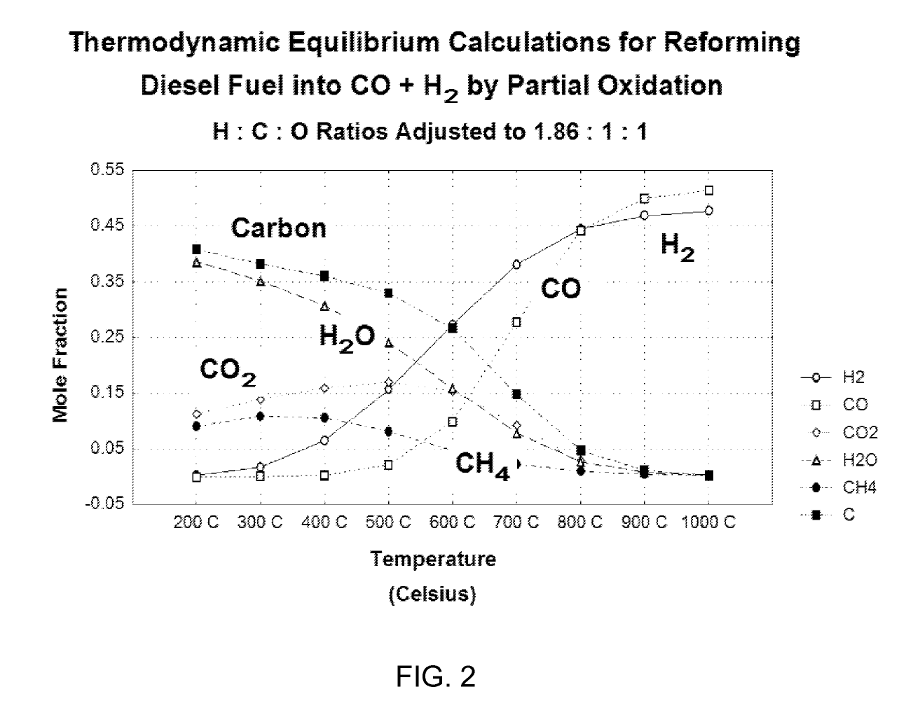

A standard thermodynamic analysis was performed in previous research to determine equilibrium conditions which favor formation of desired H₂ and CO while avoiding deposition of elemental carbon. Thermodynamic conditions were also identified which avoid excessive deep oxidation of desired products into H₂O and CO₂. Results of the thermodynamic analysis are plotted in FIG. 2. It is predicted that H₂ and CO will be overwhelmingly favored above about 950° C.-1000° C. if one atom of oxygen is transported into the reactor for each atom of carbon in the diesel fuel. In view of these and other calculations, it is predicted that at lower temperatures the deposition of carbon will be severe and that undesired deep oxidation products (i.e., CO₂ and H₂O) will form. The analysis assumes one atom of oxygen in the system for each atom of carbon in the fuel to produce one molecule of CO upon partial oxidation. The example shown is based upon an earlier sample of fuel which was analyzed and found to contain an H/C molar ratio of 1.86 to 1. It should be appreciated that even if deep oxidation products, CO₂ and H₂O, form in the initial oxidation, they will not remain stable at 950-1000° C. or above, if the system can be brought to equilibrium. It is also predicted that elemental carbon and water will be the main products at lower temperatures along with considerable quantities of carbon dioxide (CO₂) and methane (CH₄).

Referring still to FIG. 2, although the formation of carbon will be relatively small between reforming temperatures of 800-900° C., for example, it should be noted that formation of carbon will be far from negligible. A few monolayers of carbon will be sufficient to coat and poison catalysts and is unacceptable. This small initial deposition of carbon will eventually lead to further deposition of carbon and plugging of reactors.

To be absolutely certain that no carbon deposits in the reaction zone, a reaction temperature near 1000° C., preferably above 1000° C., is used if near stoichiometric quantities of oxygen are to be added to the reformer. The thermodynamic calculations predict that at 1000° C. and for a very slight excess of oxygen (1.02 moles O to 1 mole C), that the mole fraction of carbon formed at equilibrium will be less than 1×10⁻⁴⁵, which is truly negligible. Lower reforming temperatures could be used if excess oxygen is added to the system, but this will lead to formation of excess H₂O and CO₂ and lower overall system efficiency. Lower reformer temperature would also be possible if the hydrogen ratio of the fuel were increased (as with CH₄ with a 4:1H/C atomic ratio), but this will not be an option if diesel fuel alone must be used.

A. Deposition of Carbon in the Cool Zones of Reactors.

A major issue in reforming diesel fuel is cracking of the fuel and deposition of thermodynamically favored graphite as the fuel is brought from room temperature to the reforming temperature. Referring again to the thermodynamic analysis summarized in FIG. 2, it is predicted that graphite will be the major product formed at lower temperatures. At relatively low temperatures (<250° C.) slow kinetics limits the quantity of graphite formed, despite a high thermodynamic driving force. If special precautions are not taken for selection of reformer feed wall materials, a temperature near 280° C. is about the highest fuel pre-heat temperature which can be used routinely without formation of graphite. At temperatures slightly above about 280° C., graphite readily forms on walls of typical fuel feed tubes.

The initial fuel cracking temperature for formation of graphite depends upon the least stable organic compound in the fuel as well as the catalytic cracking activity of the reactor wall material used in the heating zone. Reactor wall materials such as quartz (SiO₂), alumina (Al₂O₃), or aluminosilicates were always avoided in the cool zones of reactors because of their acidic surface sites⁴. Acidic surface sites are well known to catalyze cracking of petroleum products (see for example, references 1 and 4). Catalyst supports employing silicon and aluminum have long been used in industry for cracking and reforming of petroleum. Fuel molecules can also easily crack in the gas phase and form graphite (soot). The soot can be swept to the catalyst bed and cause clogging if proper precautions are not taken. The reactor catalytic hot zone must be maintained under thermodynamic conditions which prevent growth of graphite or the graphite particles swept to the catalyst bed will catalyze their own growth and clog the catalyst bed. In general, catalytic cracking of fuel molecules on solid surfaces in the reformer cool zones is the major concern, so long as the hot zone is properly maintained to disfavor growth of graphite.

Reforming of liquid fuels is performed using a catalytic membrane reactor. In the cool zones (i.e., 300-900° C.), the reactor contains porous walls of oxygen-conducting ceramic or other material which effuse oxygen (or air) through the pores from the outer to inner walls. Oxygen is kept at very high local concentration near inner surface of the walls in the cool zones of the reactor in order to suppress formation of carbon on the walls. The arrangement allows local concentration of oxygen to be kept high where it is needed near the walls, while simultaneously minimizing the quantity of oxygen added to the system, which, if added, would reduce overall efficiency by causing deep oxidation of desired H₂ and CO to H₂O and CO₂. Walls of the porous material are coated with oxidation catalysts. An oxidation catalyst in the hot zone of the reactor operating at 1000° C. brings the system to equilibrium, which overwhelmingly favor production of synthesis gas if the carbon-to-oxygen atomic ratio is maintained at near one-to-one. The use of porous catalytic membrane walls to suppress deposition of carbon in cool zones, the use of novel perovskite oxidation catalysts and the use of catalysts tolerant to sulfur offer additional advantages over prior art methods.

B. Deterring Carbon Deposition—Reactor Walls as a Source of Oxygen.

Considering the above-described thermodynamic analysis, it was predicted that carbon deposition on reactor walls in the reformer cool zones might be suppressed if the walls could provide a local source of oxygen and maintain oxygen at high local concentration to shift the local thermodynamics to disfavor formation of graphite. In initial studies, partial success was achieved in reforming of diesel fuel by coating the cool zones of reactor walls with oxygen transport perovskite materials, which provide a source of dissociated oxygen. Moreover, perovskite-based reactor wall materials do not have acidic surface sites and will be less likely to crack hydrocarbons at low temperatures relative to reactor wall materials with acidic catalytic surface sites. Oxygen transported through bulk perovskite wall materials at T>800° C. can diffuse along the perovskite surface at temperatures as low as 400° C.

Oxides of cerium have long been embedded into the enamel of self-cleaning ovens to provide mobile active oxygen to oxidize graphite and other carbonaceous residues which are deposited onto oven walls during the cooking of food. This self-cleaning effect occurs in consumer-type ovens at temperatures as low as 500° F. (260° C.). However, as discussed below, cerium could have issues under reducing conditions if high concentrations of sulfur are present in the diesel fuel. However, sulfur poisoning of cerium will be less problematic under local net oxidizing conditions which can be designed near reactor walls.

Already by the early 1960s, silver was shown to suppress formation of carbon on reactor walls used in solid oxide fuel cell research⁵. Silver is known to transport oxygen through its bulk and has been used successfully as an oxygen transport membrane material. Thin films of silver deposited onto porous supports must be used well below the melting point of silver (962° C.). Silver used at low temperature for oxygen transport can be complemented near its melting point by using cerium or perovskite-based oxygen transport materials at higher temperature.

Finally porous inner walls effusing air into the cool zones have also been used with success to suppress deposition of carbon. Such porous inner walls have included porous stainless steel. Porous perovskite, porous yttria-stabilized zirconia, or cerium oxide materials also show promise as effusion devices for air in diesel fuel reformers. Porous inner walls provide high local concentration of oxygen to suppress deposition of carbon at the points where it is most needed. Despite high local concentration of oxygen near the reactor walls, overall concentration of oxygen in the reformer can be kept close to the desired stoichiometric limit to avoid excess production of deep oxidation products, H₂O and CO₂.

It should be appreciated that the thermodynamic conditions necessary for preventing the deposition of carbon using various types of carbonaceous fuel were already well established by the early 1960s by workers in solid oxide fuel cell research.⁵ Carbon deposition boundaries were determined from triangular phase diagrams.⁵ Examples of C—H—O diagrams demarcating carbon deposition boundaries and regions of deep oxidation are discussed by E. J. Cairns and A. D. Tevebaugh, as quoted by J. G. Smith.⁵ Such diagrams predict that carbon can be suppressed at relatively low temperatures if the ratio of hydrogen or oxygen or both are increased in the system relative to carbon. Carbon deposition can be suppressed at low temperature in reformer cool zones, if local concentration of oxygen can be kept very high near the walls.

As an example showing the effect of increasing the concentration of hydrogen in the system, initial thermodynamic calculations show that for the case of partial oxidation of methane, CH₄, in the reaction: CH₄+O₂=2H₂+CO, a slightly off stoichiometric atomic ratio of H:C:O of 4:1:1.02 (rather than 1.86:1:1.02 in diesel fuel), allows a reforming temperature as low as 875° C. without deposition of carbon. The higher quantity of hydrogen in methane allows reforming to proceed at lower temperatures without formation of carbon at equilibrium. Likewise, fuels such as propane (C₃H₈), methanol (CH₃OH), other oxygenated fuels, and the like, can be reformed at lower temperatures relative to diesel fuel or JP-8 using near-stoichiometric quantities of oxygen without formation of carbon because of more favorable ratios of H:C:O in the equilibrium mixture and thus lower thermodynamic driving force for the deposition of carbon. Those familiar with reforming fuels with higher hydrogen or oxygen content relative to that in diesel fuel would appreciate that the lower reforming temperatures used with success with these fuels will not work when applied to diesel fuel because of the greater thermodynamic driving force for the deposition of carbon in the case of diesel fuel.

Other options used to suppress deposition of carbon, which were well established by the early 1960s, are to add steam (H₂O) or to re-circulate steam and CO₂ exiting the fuel cell exhaust back into the inlet of the reformer.⁵ Although the inclusion of steam can be very effective in suppressing deposition of carbon, steam is preferably not added, or is used at a minimum, to the present fuel reformer for production of synthesis gas because of energy efficiency penalties. Added oxygen and hydrogen from a mixture of re-circulated H₂O and CO₂ will suppress formation of carbon if CO₂ and H₂O can be reacted and dissociated and if the system can be brought to equilibrium. The thermodynamic calculations show that if only half of the fuel cell exhaust could be re-circulated to yield an H:C:O ratio of 2.79:2:3.93 in the fuel reformer, and if the system could be brought to equilibrium within the reactor, then the reforming temperature of the hot zone could easily be lowered to 700-750° C. without danger of deposition of carbon in the hot zone.

One drawback of re-circulating steam and CO₂ is that ultimate conversions to H₂ and CO in the reformer are highly endothermic. Extra heat would need to be provided for the net endothermic reactions: H₂O+C=H₂+CO and CO₂+C=2CO, dropping overall system efficiency to levels which are likely to be unacceptable. As will be shown in later calculations, there is not heat to spare in the fuel reformer to drive these endothermic reactions, and some of the diesel fuel, CO or H₂ would need to be oxidized to provide the heat for this method of suppression of the deposition of carbon. Another major disadvantage of re-circulation of H₂O and CO₂ from the fuel cell exhaust is the accumulation of impurities in the reformer, in particular, sulfur. This will be especially severe in reforming JP-8, in which case sulfur impurities could quickly accumulate in the reformer starting from an already high initial concentration of 3,000-10,000 ppm (0.3 to 1% by mass). Re-circulation has other issues, including the energy consumed in pumping exhaust products back into the fuel reformer.

It should be appreciated that once CO is formed in the fuel reformer, that temperatures between the fuel reformer and fuel cell must be maintained at 1000° C. (if stoichiometric quantities of oxygen are used, and if steam and re-circulation are precluded) to avoid the Boudouard reaction: 2CO=CO₂+C. The Boudouard reaction has been well known since at least 1905 and can be a major mechanism for the deposition of carbon if proper precautions are not taken. For example, if the fuel cell were to be run at temperatures below 1000° C., carbon will likely deposit onto “cold” surfaces (800° C.<T<1000° C.). If a fuel cell must be run below 1000° C. (for example in order to avoid thermal degradation of its components), carbon deposition at the entrance to the fuel cell might be suppressed by adding oxygen to the fuel reformer exhaust using oxygen transport membranes lining the walls. However, this will lower overall system efficiency because of deep oxidation of some H₂ and CO into H₂O and CO₂.

For all alkanes, the general molecular formula is CₙH₂ₙ₊₂. This implies that the hydrogen to carbon atomic ratio will always be slightly above two. For all alkanes, a temperature of 1000° C. with a very slight stoichiometric excess of oxygen (C:O of 1:1.02) should be sufficient for the suppression of the formation of carbon. However, for naphthalene with formula, C₁₀H₈, the H:C atomic ratio is 8:10 (or 0.8:1), which is significantly lower than the 2:1 atomic ratio in alkanes. For a compound such as benzo[α]pyrene], with formula C₂₀H₁₂, the H:C atomic ratio is only 12:20 (or 0.6:1). (For comparison the H:C average atomic ratio of a typical bituminous coal is 0.8:1, according to G. A. Olah and A. Molnár¹). The much lower H:C atomic ratios in the polycyclic aromatic compounds imply that larger quantities of oxygen must be used to prevent deposition of carbon (an H:C:O ratio of 1:1.67:1.69 is required in the case of benzo[α]pyrene at 1000° C.). In reforming diesel fuel, the more easily reformed alkanes react first, leaving a residuum of more refractory polycyclic aromatic compounds. Accumulated unreformed polycyclic aromatic compounds with lower H:C ratio could deposit carbon if run under conditions assumed for high H:C ratio if precautions are not taken.

The simplest solution to suppress deposition of carbon without addition of steam or use of re-circulation is simply to add molecular oxygen in excess of that required for stoichiometric production of CO. This, however, will be at the expense of overall system efficiency because of the formation of deep oxidation products, CO₂ and H₂O, in the fuel reformer. Dropping the overall system efficiency in a combined reformer-fuel cell system may likely be unacceptable in most applications, removing any advantages which solid oxide fuel cells might have had relative to diesel engine electric generators.

Although some researchers have attempted to suppress formation of elemental carbon on catalysts through kinetic control (i.e., by poisoning catalytic sites or surface arrays which favor formation of graphite), this is extremely challenging at the high temperatures involved, especially considering the very high thermodynamic driving force for the formation of graphite. Furthermore, graphite, once formed, is autocatalytic for its own formation. Deposition of carbon will thus form exponentially and spiral out of control if reactors are run under thermodynamic conditions which favor the formation of graphite and if even a small quantity of graphite initially nucleates. Furthermore, kinetic control for suppression of graphite must be successful not only on catalysts, but also on reactor wall components. Finally, if nucleation of graphite occurs in the gas phase and if soot deposits onto catalysts and onto reactor wall components, graphite will catalyze its own formation and exponentially grow out of control, even if kinetic control on catalysts and wall materials were perfect. Kinetic control of graphite is not considered to be a viable option, and, therefore, thermodynamic conditions which prevent formation of graphite have been sought.

If overall system efficiencies above 40% must be maintained, and if the addition of excess steam is precluded, as well as re-circulation of fuel cell exhaust, or addition of excess oxygen, then, in view of the thermodynamic analysis, the diesel fuel reforming reaction should be carried out near 1000° C. (or above) to suppress formation of carbon. If catalysts are to be used, this implies that the catalysts must be stable at 1000° C. and under the harsh chemical operating conditions in the reformer. This includes catalyst stability towards sulfur. The thermodynamics of sulfide formation is considered in the following section.

C. Thermodynamic Analysis of Sulfide Formation.

Another major consideration in the design of a fuel reformer is the identification of possible catalysts which can resist formation of bulk sulfides and which are stable at the desired operating condition of 1000° C. Some stable sulfide compounds that form to poison common catalysts are shown in Table 1.

TABLE 1
Stable Sulfides Form to Poison Common Catalysts

| | | | |
|---|---|---|---|
| NiS | m.p. | 797° | C. |
| PdS | d. | 950° | C. |
| FeS | m.p. | 1199° | C. |
| ZnS | b.p. | 1185° | C. |
| Ag₂S | m.p. | 825° | C. |
| Ce₂S₃ | d. | 2100° | C. |
| CoS | m.p. | >1116° | C. |
| MoS₂ | m.p. | 1185° | C. |
| MgS | d. | >2000° | C. |
| Cu₂S | m.p. | 1100° | C. |
| La₂S₃ | m.p. | 2150° | C. |
| RuS₂ | d. | 1000° | C. |
| WS₂ | d. | 1250° | C. |
| PtS₂ | d. | 250° | C. |
| IrS₂ | d. | 300° | C. |
| BaS | m.p. | 1200° | C. |
| SrS | m.p. | >2000° | C. |

For the purpose of identifying elements which are resistant to formation of bulk sulfides, Ellingham diagrams are extremely useful. An Ellingham diagram such as that published by L. S. Darken and R. W. Gurry⁶, plotting the Gibbs' Free Energy of sulfide formation was used. From such plots showing the Gibbs' Free Energy of formation, one can identify the elements which form the most stable sulfides. From such diagram, it is concluded that cerium, Ce, forms the most stable sulfide of the common elements, followed by calcium, Ca. It is for this reason that compounds of calcium are injected into coal-burning process streams to remove sulfur by forming solid CaS and why compounds of cerium are sometimes added to diesel fuel to getter sulfur by forming stable solid cerium sulfides or cerium oxy-sulfides, CeOS. Catalyst supports based upon compounds of cerium and calcium (and also magnesium) can provide some temporary protection for metal catalysts by gettering sulfur. However, if large quantities of sulfur are continuously present in the reaction stream, such supports are likely to eventually be saturated with sulfur, allowing metal catalysts to be poisoned. Although cerium forms excellent oxidation catalysts, cerium may not be recommended in beds of catalysts in fuel reformers if sulfur is present in the quantities normally found in diesel fuel and JP-8. Cerium oxide-based catalysts, however, would not be ruled out in oxygen effusers at the walls of the reformer where local concentrations of oxygen remain high.

Elements with Gibbs' Free Energies plotted nearest the top of the Ellingham diagram, such as iridium (Ir) and platinum (Pt) form the least stable sulfides of the elements. By plotting Gibbs' Free Energy of the reaction, 2H+S₂=2H₂S for the H₂S/H₂ ratio of 1/1. The diagram predicts that at 1000° C., PtS will not be stable relative to H₂S, and that PtS, if it does form, will react: PtS+H₂=Pt+H₂S. Elemental Pt and H₂S are the thermodynamically preferred products. Likewise, sulfides of Ir and Rh will react with hydrogen in the system and be reduced to the metal. From such diagrams, it is predicted that elements including Ir, Pt, Ag, Co, Mo, W, Cu and Fe will not form bulk sulfides at 1000° C. if the H₂S/H₂ molar ratio is kept below about 1:10,000. Thus, it is predicted that, for example, metal gauzes of Pt, Rh, Pt—Rh and Ir should make excellent catalysts for reforming of diesel fuel and JP-8 at 1000° C. and above. Melting points of the metals are: Pt (1772° C.), Ir (2410° C.), Rh (1966° C.).

These metal catalysts and many of their alloys, in the form of wire gauze, can easily operate at the desired 1000° C. or considerably higher without danger of melting. Oxygen and fuel fed to a wire gauze of Pt—Rh would form a system with rapid heating of the wire, oxidant and fuel well beyond 1000° C., which will thermodynamically favor formation of H₂ and CO, with little to no chance of carbon forming on the wire. This would be somewhat analogous to the use of nickel-wire gauze which was used already in the 1960s to reform methane (low sulfur) into H₂+CO as a fuel for solid oxide fuel cells⁷. Methane, oxygen and steam readily transform into syngas when passed over nickel heated to 750-900° C. The disadvantage of the use noble metal gauze is the cost. This may be less of a concern in reforming JP-8 for military purposes, but may limit applications in commercial diesel vehicles.

A ratio of H₂S/H₂ of 1/1 at standard thermodynamic conditions represents an extremely high concentration of sulfur relative to that found in typical fuel reformer systems. For more typical ratios of H₂S/H₂ between 1/10³ and 1/10⁴, the Ellingham diagram predicts that bulk sulfides of additional elements including silver (Ag), cobalt (Co), tungsten (W), molybdenum (Mo), iron (Fe) and copper (Cu) will not be stable at 1000° C. and will be reduced to the metals. Thus, as far as formation of bulk sulfides is concerned, these metals could be potential reforming catalysts in the form of a wire gauze-if other constraints do not preclude their use. Melting points of these elements are: Ag (961.93° C.), Co (1495° C.), W (3410° C.), Mo (2610° C.), Fe (1535° C.) and Cu (1083° C.). Silver and copper, in their elemental form, might be ruled out for use in wire gauze because their melting points and vapor pressures will not allow long-term operation at 1000° C. and above, which is needed for suppression of carbon deposition. Tungsten and molybdenum in wire gauze form have more than sufficient thermal stability, but might suffer from formation of volatile oxides (MoO₃ and W₂O₅). However, under the net reducing conditions in a fuel reformer, tungsten and molybdenum should remain metallic. Cobalt is predicted to certainly remain metallic under the reducing conditions of the reformer, but elemental cobalt could suffer from its relatively high vapor pressure at 1000° C. and above. Iron passes thermodynamic tests as a possible candidate as a low cost catalyst, and might be used as a wire gauze. Iron should remain in a reduced form under reformer conditions at 1000° C., but its relatively high vapor pressure may lead to evaporation of the gauze over time.

From the above analysis, a number of metals in Group VIIIB of the Periodic Table of the Elements, including Pt, Ir, Rh, Co and Fe were selected as having potential as catalysts for diesel fuel partial oxidation at 1000° C. and with high sulfur concentrations, so long as the H₂S/H₂ ratio does not exceed 1/10³. In addition, Mo and W were not ruled out. The noble metals, Pt, Ir and Rh are well known to adsorb and dissociate molecular oxygen and act as excellent oxidation catalysts. The adsorbed, mobile oxygen in a dissociated form on the surface of the noble metal catalysts would then be free to react with adsorbed organic molecules, including the polycyclic aromatic compound or graphite temporarily formed upon initial cracking of organic compounds.

At the high reforming temperatures, supported dispersed noble metal catalysts will be very difficult to maintain in a dispersed form because of the high driving force for sintering and agglomeration. Metal gauzes, despite relatively low surface area, will remain stable nearly indefinitely, and are the catalysts of choice. Gauzes of Pt—Rh are recommended for reforming of JP-8 for military applications, in which cost is less of an issue. If it were not for their high cost, other catalysts would not need to be considered for civilian use.

In addition to the metallic elements above, it is predicted that a variety of oxide materials will also serve as partial oxidation catalysts. A common feature of oxides serving as oxidation catalysts is the ability of the oxides to adsorb and dissociate molecular oxygen and to transport oxygen in a dissociated form through the oxide bulk via oxygen vacancies.

Considering previous work at Eltron Research Inc. with mixed electron and oxygen ion conducting membranes, and knowing that perovskite materials can be designed to adsorb and dissociate molecular oxygen⁸, as with noble metals, and can be designed for high oxygen ion mobility and high electron conductivity,⁹ it was predicted that perovskite-type materials might form superior catalysts for the partial oxidation of diesel fuel. Furthermore, perovskites are refractory oxides, some of which retain their stability at 1000° C. and above and under the harsh chemical conditions of fuel reformers.¹⁰⁻¹⁴ Materials such as La₁₋ₓSrₓFeO_{3-δ} have been designed to possess both good electron conductivity, which is essential for electron transfer and reduction of molecular oxygen (O₂+4e⁻=2O²⁻), as well as high oxygen anion mobility desired for oxidation reactions. Oxygen ion mobility is enhanced in perovskites by the creation of oxygen ion vacancies both on the surface and in the bulk. Addition of strontium Sr ions to the LaFeO₃ lattice produces oxygen vacancies by removing positive charge in the lattice as La³⁺ ions are replaced by Sr²⁺. Substitution of two Sr²⁺ ions for two La ions creates one O₂₋ vacancy. Oxygen vacancies allow oxygen ions to diffuse through the crystal bulk, hopping from vacancy to vacancy. Oxygen vacancy sites on the catalyst surface also form active sites for the adsorption and dissociation of molecular oxygen, CO₂, and water. Iron near oxygen vacancy sites on the surface also possesses enhanced catalytic activity for the adsorption and dissociation of hydrocarbons, including aromatic hydrocarbons.

Loss of some lattice oxygen by desorption of molecular oxygen at 1000° C. (and thus loss of two O²⁻ ions from the perovskite lattice for each O₂ molecule desorbed) allows some of the Fe³⁺ ions to be reduced to Fe²⁺. Electrons are transferred between Fe²⁺ and Fe³⁺ via intervening O²⁻ ions, giving the crystal lattice high electron mobility. Electron conductivity is critical for redox reactions, including the reduction of molecular oxygen and oxidation of the hydrocarbons in diesel fuel.

It should be appreciated that not all materials with the perovskite crystal structure remain stable under the harsh operating conditions required in a diesel fuel reformer. For example, materials such as La₁₋ₓSrₓCoO_{3-δ}, La₁₋ₓSrₓNiO_{3-δ}, and La₁₋ₓSrₓMnO_{3-δ} can be reduced under reformer operating conditions if partial pressure of oxygen is too low. As noted above, in these formulas x is greater than 0 and less than 1 (0<x<1), and δ is the number of oxygen vacancies in the resulting oxide crystal lattice.

In initial studies, over 40 catalyst formulations were screened. These contained various perovskites and other catalysts and catalyst supports for operation at 1000° C. to reform commercial diesel fuel (Conoco-Phillips D-2). The fuel was used directly as received from the pump without modification. Yttria-stabilized zirconia (YSZ) was found to be one of the best catalyst supports tested. As in the case with perovskites, the substitution of lower-valence Y³⁺ ions for Zr⁴⁺ creates oxygen vacancies in the ZrO₂ lattice and produces oxygen anion mobility, although not to as great an extent as in perovskites. The additional mobile oxygen from the zirconia support might aid oxidation of diesel fuel. This may provide an advantage over supports such as Al₂O₃ and MgO, in which oxygen anions have limited mobility even at 1000° C.

From solid oxide fuel cell studies, it is found that elements in yttria stabilized zirconia and perovskite electrodes can interdiffuse at 1000° C. producing the pyrochlore, La₂Zr₂O₇, at the zirconia-perovskite interface. Although this may be problematic in fuel cells for which oxygen must be transported through the pyrochlore, it appears to be less problematic in granules or pellets of partial oxidation catalysts, in which case a pyrochlore at the zirconia-perovskite interface would less likely affect catalysis at the outer perovskite-gas interface.

### II. Catalysts for Reforming Sulfur-containing Diesel Fuel

Catalysts were prepared which are low cost and optimized for reforming sulfur-contaminated commercial diesel fuel such as straight-from-the-pump automotive fluids, and other fuels that are difficult to reform, into H₂+CO. Those catalysts with long-term stability under the harsh reformer reaction conditions at 950-1000° C. were identified.

A. Synthesis and Characterization of Perovskite-Type Catalysts.

Oxide perovskites with the general formula A′₁₋ₓA″ₓB′_{1-y}B″_{y}O_{3-δ} where A′=La and Y; A″=Ca, Sr, Ba, and B′ and B″=Co, Fe, Mn, Ru, Ce and Mo are prepared and dispersed onto porous supports such as MgO and 8-10 mole % YSZ. Oxides with the perovskite crystal structure are designed for rapid adsorption and dissociation of molecular oxygen, rapid diffusion of oxygen, and good electron transport properties. Perovskites, such as La₁₋ₓSrₓCoO_{3-δ}, which decompose under high temperature reducing conditions are used as a means of highly dispersing supported catalytic metals, (i.e., Co/SrO/La₂O₃). Supports with basic surface sites such as MgO and yttria stabilized ZrO₂ were sought rather than those such as Al₂O₃ with acid surface sites to avoid rapid deposition of carbon. Some forty distinct catalysts were synthesized including La₁₋ₓSrₓCoO_{3-δ}, La₁₋ₓSrₓMnO_{3-δ}, La₁₋ₓSrₓFeO_{3-δ}, La₁₋ₓCaₓFeO_{3-δ}, La₁₋ₓSrₓFe_{1-y}Co_{y}O_{3-δ}, La₁₋ₓSrₓFe_{1-y}Ru_{y}O_{3-δ}, BaCe_{1-y}Fe_{y}O_{3-δ} and related compounds, supported on both MgO and 8 mole % YSZ. Structures were verified using x-ray powder diffraction, and synthesis was generally successful.

B. Optimization of Perovskite-Type Catalysts.

The class of materials known as perovskites takes its origin from the mineral, perovskite, named in honor of the Russian, Graf L. A. Perovsky, by the mineralogist, Gustav Rose, in 1839.¹⁵ The parent perovskite compound has the nominal formula, CaTiO₃.⁹ Calcium occupies the so-called A sites and titanium the B-sites. Substances with this crystal structure are used in many oxidation catalysts. The ability of these materials to allow diffusion of oxygen through the crystal lattice by a vacancy hopping mechanism provides a source of dissociated oxygen for oxidation reactions. In practice, many of the synthetic perovskite compounds (as well as the parent CaTiO₃) have slight tetragonal or rhombohedral distortions from the ideal cubic structure.

A wide variety of elements can be substituted into the A and B-sites of the perovskite crystal lattice.⁹ A-sites contain larger cations of Ca, Ba, Sr, and La, for example. B-sites contain smaller transition metal cations of Fe, Co, Ru, Ni, Cr, Mo, and Mn. In practice, most of the metal elements of the periodic table can be substituted into the A or B-sites, giving perovskite materials a wide range of physical and catalytic properties.

By mixing cations such as La³⁺ and Ca or La and Sr²⁺ at the A-sites, oxygen vacancies are created at the oxygen anion sites to produce non-stoichiometric compounds such as La₁₋ₓSrₓCrO_{3-δ}, La₁₋ₓSrₓCoO_{3-δ}, La₁₋ₓSrₓMnO_{3-δ}, La₁₋ₓCaₓFeO_{3-δ}, La₁₋ₓSrₓFeO_{3-δ}, and the like. For every two La³⁺ cations replaced by two Sr²⁺ cations, one O²⁻ ion can be eliminated from the lattice to retain charge neutrality, thus creating an oxygen vacancy. The oxygen vacancies so created allow oxygen anions to hop from vacancy to vacancy, which creates high rates of oxygen diffusion through the oxide lattice. High oxygen mobility, providing a ready flow of oxygen to the catalyst surface is essential in oxide oxidation catalysts. Oxygen vacancies created on the perovskite surfaces (see, for example, Henrich and Cox¹⁶) provide very active catalytic sites for the adsorption and dissociation of molecular oxygen, for CO₂, for water, and for various organic compounds.

Doping of stoichiometric perovskite compounds such as LaCrO₃, LaCoO₃, LaFeO₃, LaMnO₃, etc. with Ca²⁺, Sr²⁺, and Ba²⁺, etc. and also desorption of molecular oxygen at high temperatures, also allows transition metals of mixed valence, such as Fe²⁺—Fe³⁺, Co²⁺—Co³⁺, Mn²⁺—Mn³⁺, and the like, to be present in neighboring B-sites. This mixed valence of the transition metals at neighboring B-sites allows electrons to jump (via intermediate p-orbitals of oxygen anions^{17,18}) between the ²⁺ and ³⁺ cations at the neighboring B-sites. This can produce high electron mobility in the lattice. High electron conductivity is essential for electron transfer reactions such as the reduction and dissociation of molecular oxygen: O₂+4e⁻=2 O²⁻. Exemplary optimized catalysts were proven to be stable at 1000° C. while maintaining catalytic activity in a two month continuous test using commercial sulfur contaminated diesel fuel as-received from the automotive pump. A bed of suitable oxide catalyst is used in the reactor hot zone to reform the diesel fuel at 1000° C. or above.

C. Fabrication Process—Preparation of Perovskite Catalytic Materials.

Perovskite powders used as the diesel fuel reforming catalysts were prepared by standard solid-state processing procedures. This involved synthesis of perovskite compounds from starting materials and subsequent formation into catalyst granules, catalyst pellets and supported catalysts. Desired compositions of the perovskite powders were prepared from mixtures of metal oxides, such as La₂O₃, Fe₂O₃ and Mn₂O₃ and where appropriate, metal carbonates, such as SrCO₃ and CaCO₃. Powders of starting materials were placed in polyethylene containers containing several cylinders of yttria-stabilized zirconia (YSZ) grinding media. Isopropyl alcohol was also added as a grinding aid. The slurries were rotated in the bottles for several hours using a ball mill, which produces a homogenous mixture of the starting materials. Isopropyl alcohol was then removed by evaporation.

Solid-state reactions were initiated by placing the mixture of starting materials in an alumina crucible and firing in air at temperatures typically above 1200° C. The reaction temperature was usually held for 12 hours. This procedure was typically repeated with an intermediate re-grinding of powders in order to ensure intimate contact and mixing of the powders and to allow the solid-state reactions to go to completion. This procedure typically produced a single phase perovskite product. The perovskite powders were then ground to 45 mesh size. Verification of production of the perovskite crystal structure and absence of starting materials or undesired side products was verified using x-ray powder diffraction. X-ray diffraction was performed using a Philips PW1830 X-ray Diffractometer. The output of diffraction angle (2θ) versus x-ray diffraction intensity was collected and analyzed with a Philips X-pert software package.

Prior to forming catalyst pellets or granules, the perovskite powders were subjected to attritor milling to reduce particle size. This yielded powders with a distribution of sizes in the micron and submicron range. Attritor milling was performed using a Union Process Model 01 Attritor equipped with an yttria stabilized zirconia tank and yttria stabilized zirconia agitator arms. For this process, typically 1.5 lbs of 5 mm diameter, spherical, yttria stabilized zirconia grinding media were placed in the attritor tank. Then, approximately 120 mL of isopropyl alcohol was added followed by approximately 100 g of the 45 mesh powder. The powder was subjected to attrition milling for four hours. After attrition milling, the isopropyl alcohol was removed by evaporation. The powder was then sieved to 170 mesh.

D. Catalyst Surface Area Analysis.

Surface area analysis of the catalysts was performed by Brunauer-Emmett-Teller (BET) gas adsorption methods (see, for example, S. Lowell and J. E. Shields,¹⁹) using a Quantachrome Nova 2000e surface area analyzer/porosimeter. Surface areas were determined from nitrogen volume/partial pressure isotherms. The BET method used the measurement of the uptake of nitrogen as a function of partial pressure. The surface area was calculated from the following equations:

$$\frac{x}{n ( 1 - x )} = \frac{1}{{cn}_{m}} + \frac{( c - 1 ) x}{{cn}_{m}} \qquad ( 1 )$$

where x=relative pressure (P/Pₒ), nₘ=number of moles of gas to form a monolayer of uniform coverage, c=a constant, S=specific surface area of the sample, N₀=Avogadro's number, σ⁰=cross sectional area of the probe molecule (i.e., N₂), and n=number of moles adsorbed. A plot of x/n(1−x) versus x gives nₘ and c. Equation 2 then allows the specific surface area to be determined.

Results showed typical surface areas of 7 m² g⁻¹. For perspective, a bed containing 15 g of catalyst would posses a surface area of 105 m². No attempts were made to further improve the surface area of the perovskite catalysts, because it was deemed that use at 1000° C. would sinter higher surface area materials, negating efforts to improve catalyst surface area. From past research, it has been shown that the perovskites largely retain their initial surface area after extended use at elevated temperatures.

E. Powder X-Ray Diffraction (XRD) Analysis of Perovskite Catalysts.

Powder x-ray diffraction data show characteristic peaks assigned to the perovskite crystal structure for materials such as La₁₋ₓSrₓCoO_{3-δ} of the catalyst powder. The patterns indicate that the material is single phase (no undesired side products), that the starting materials have been consumed, and that the catalyst has the desired perovskite crystal structure.

F. Scanning Electron Microscopy (SEM) and Energy Dispersive X-ray (EDX) Measurements.

Scanning electron microscopy was performed using a JEOL T-200 Scanning Electron Microscope. Energy dispersive x-ray analysis was performed using a Princeton Gamma Techniques Energy Dispersive X-ray unit attached to the SEM. The x-ray energy analyzer also allowed mapping of elemental constituents. Energy dispersive x-ray analysis was performed before and after diesel fuel reforming experiments. This was important in detecting or verifying the absence of carbon and sulfur which were not as readily detectable in small concentrations by x-ray powder diffraction.

G. Preparation of Porous Catalyst Pellets and Granules.

Porous catalyst pellets and granules were made by mixing the perovskite powder with corn starch as pore former, and polyvinyl butyrate (PVB) as binder, in the ratio of 10:6:1, by weight. The starch and binder burn upon firing the mixture in air, leaving pores. Starch is a standard inexpensive filler material used to form porous catalytic pellets. Grinding media were added to the starch and perovskite powders to aid in the mixing, performed by ball-milling in acetone for four hours. After mixing, the solution was dried, sieved to 45 mesh and uniaxially pressed into 2¾″ diameter disks, which served as so-called green bodies, which could then be fired in air. Each disk weighed 40-50 g. The starch and binder were burned away, and the perovskite powder was sintered by heating the green-body pellets at a rate of 1° C. min⁻¹ to the desired sintering temperature, usually >1,200° C., dwelling at the sintering temperature for four hours, and then cooling at a rate of 1° C. min−1 to room temperature. To form smaller catalyst granules, the sintered porous perovskite pellets were crushed into smaller pieces. The smaller pieces were separated by size using metal wire sieves. Sieves of 6 and 12 mesh were stacked, separating catalyst granules with sizes between 6 and 12 mesh.

H. Perovskite Catalyst Coating onto Porous Support Material.

In addition to use of pressed porous perovskite pellets and granules which contained only the perovskite material, perovskite catalysts were also dispersed onto various porous refractory ceramic support materials including MgO and 8 mole % yttria-stabilized zirconium oxide. In addition, refractory perovskites were also used as supports for some of the more catalytically active perovskites. Catalysts were coated onto support materials using three different methods. The first procedure used a solvent slurry which led to a coating of dense perovskite on the support material. The second procedure used a solvent slurry with pore formers to coat porous perovskite catalyst to the support material. The third procedure coated the support material with a polymeric precursor using the Pechini process. All three coating methods are discussed below.

1. Solvent Slurry for Producing Dense Catalyst Coatings

The following was a general composition for a catalyst slurry:

5.00 g Perovskite particles

5.90 g Toluene

1.50 g Ethanol

0.10 g Butyl Benzyl Phthalate (BBP)

0.25 g Polyvinyl Butyrate (PVB)

The slurry materials were mixed in small polyethylene bottles with five 5 mm diameter spherical yttria-stabilized zirconia grinding media to aid mixing. The slurry was ball milled for four hours to ensure a homogenous mixture. The slurry was then coated onto a porous catalyst support, heated and sintered.

2. Solvent Slurry for Producing Porous Catalyst Coatings

In a variation of Method 1, above, a pore forming material was included in the composition, as follows:

5.00 g Perovskite powder

7.20 g Toluene

0.75 g Ethanol

0.10 g Butyl Benzyl Phthalate (BBP)

0.28 g Polyvinyl Butyrate (PVB)

2.50 g Cornstarch (pore former)

The slurry materials were again mixed in small polyethylene bottles with five 5-mm spherical yttria-stabilized zirconia grinding media to aid mixing. The slurry was ball milled for 4 hours to ensure a homogenous mixture. This solution was then coated onto the porous catalyst support, heated to burn out the pore former, and sintered.

3. Perovskite Catalyst Coatings using Polymeric Precursors by the Pechini Process.

A molar ratio of 3.75:11.25:1 of citric acid:ethylene glycol:metal cations was used to form the desired mixed conducting ceramic material by the Pechini process. Metal nitrates served as the source of the metal cations. An intimate mixing of metal nitrates occurs at a molecular level when they are dissolved and mixed in solution. Citric acid was used as a chelating agent for the metal cations. Ethylene glycol was reacted with the citric acid to form organic esters. Heating the solution forms polymeric gels, which were then coated onto the various porous catalyst supports. The chemistry of the Pechini Process is applicable to a wide variety of metal cations.

All polymers were made using 99.5% anhydrous citric acid (Aldrich) and 99% ethylene glycol (Aldrich). Metal cation precursors used included 99+% strontium nitrate (Aldrich), 99.99% lanthanum nitrate hexahydrate (Aldrich), 98% cobalt nitrate hexahydrate (Alfa Aesar) and 99.98% manganese nitrate hydrate (Alfa Aesar). Heating was performed using a Corning Stirrer/Hot Plate. All weight measurements were made using a Mettler-Toledo BD601 portable balance with a 600-gram maximum capacity. These preparations were conducted in Pyrex glass beakers.

Twelve grams of citric acid was dissolved in 12 mL of deionized water. To this solution, a total of 0.0166 moles of metal cations were added. After all nitrates were dissolved in solution, 10.5 mL of ethylene glycol was added. The solution was heated to 80° C., and maintained at 80° C. for one hour while being continuously stirred using a magnetic stirring bar. Heating at 80° C. evaporates water and initiates polymerization, producing a viscous liquid. The viscosity of the solution increases with increased polymerization and evaporation of water. The viscous polymer is then coated onto the porous catalyst supports.

The perovskite catalyst slurries or polymer gel containing perovskite precursors were coated onto porous catalyst supports of MgO, 8 mole % yttria stabilized zirconia, or porous perovskites. The porous support material was immersed into the perovskite catalyst slurries or polymer gel. After the support was immersed, the coated support was removed and any excess slurry or gel was allowed to drain off. The coated support material was then heated on a hot plate to approximately 200° C. to evaporate volatile components. The catalyst-coated support was then heated to 1000° C. using a heating rate of 1° C. min⁻¹ and was then ready for testing.

### III. Catalyst Testing Procedure.

Catalysts prepared as described above were tested for efficiency in reforming diesel fuel at reactor temperatures of 950-1000° C. Thermodynamic analysis indicated that reforming temperatures of at least 950-1000° C. were necessary to avoid deposition of carbon. Because decomposition of polycyclic aromatic compounds in diesel fuel forms good nucleation sites for graphite, it was deemed unlikely that kinetic control could be achieved at lower temperature, and that only tests above 950° C. and preferably at 1000° C. would lead to viable catalysts. Some forty distinct catalyst formulations were tested at 1000° C., using pump grade, sulfur contaminated (about 200 ppm by mass) D-2 diesel fuel. Tests were typically run continuously at temperature for one full week. Some catalysts such as La₁₋ₓSrₓCoO_{3-δ} and La₁₋ₓSrₓMnO_{3-δ} showed conversion of diesel fuel into CO, CH₄ and CO₂ very near 100% for 50-60 hours, but declined within one week if the partial pressure of oxygen in the reactor was too low. In the case of La₁₋ₓSrₓCoO_{3-δ}, the perovskite decomposes to produce highly dispersed, highly active metallic cobalt, but at 1000° C. the cobalt grew into large crystallites by Ostwald ripening, lowering surface area and catalytic activity. The manganese showed similar behavior. A catalyst formulation using La₁₋ₓSrₓFeO_{3-δ} supported on 8 mole % YSZ, although showing lower initial catalytic activity, retained its activity and was the preferred catalyst for long-term (two month) tests.

Below are summarized calculations which were used in evaluating the activities and conversion rates of the various catalysts. From the combustion analysis of the fuel, which gave mass percents of hydrogen and carbon in the fuel of 13.01% and 87.00%, respectively, the density of the fuel (0.8526 g mL⁻¹ at 25° C.), and textbook values for atomic masses of H=1.0079 and C=12.011, the moles of H and C in a 100 g sample were calculated to be 12.908 mol H and 7.243 mol C. From these numbers the ratio of moles of hydrogen atoms to moles of carbon atoms is found to be: 12.908 mol H/7.243 mol C or 1.781/1. The average hydrocarbon molecular formula of the diesel fuel is thus C₁H_{1.781}. (These values differ slightly from an earlier sample with average formula C₁H_{1.86}).

From the ratio of H:C atoms in the diesel fuel, the H₂:CO gas volume ratios which can be expected for both pure steam reforming and pure dry partial oxidation of the diesel fuel can be calculated. In the case of pure steam reforming of hydrocarbons of general formula CₓH_{y}, the production of synthesis gas by steam reforming can be represented by the following equation:

CₓH_{y}+xH₂O→xCO+(x+½y)H₂ (3)

If it is assumed that all the hydrocarbons are consumed in this reaction and that all components are gaseous, then from the coefficients of the equation, the ratio of gas volumes of H₂:CO is (x+½y):x. Using x=1 and y=1.781 from the analysis of the diesel fuel, the maximum H₂:CO gas volume ratio is [1+(½)1.781]:1 or 1.8905:1.

In the case of pure dry partial oxidation of the hydrocarbons in diesel fuel, the production of synthesis gas is given by the following equation:

CₓH_{y}+½xO₂→xCO+½yH₂ (4)

If one assumes that all the hydrocarbons are consumed in this reaction, then from the coefficients of the equation, the ratio of gas volumes of H₂:CO is ½y:x, or 1.789/2:1=0.8905:1. In cases for which both steam and oxygen are present, and for which both steam reforming and direct partial oxidation take place, the experimental H₂:CO ratio will lie between 1.89:1 and 0.89:1.

Utilizing the specific gravity of the diesel fuel along with the mass percents, masses of hydrogen and carbon per volume of liquid diesel fuel are calculated. The mass of hydrogen/mL diesel fuel is (0.8526 g fuel/mL)(0.1300 g H/g fuel)=0.1109 g H/mL diesel fuel. Similarly the mass of carbon/mL of diesel fuel is: (0.8526 g fuel/mL)(0.8700 g C/g fuel)=0.7418 g C/mL diesel fuel.

Using the textbook values for atomic masses one can calculate the number of moles of hydrogen and carbon in each mL of diesel fuel.

Hydrogen:(0.1109 g H/mL fuel)(1 mol H/1.0079 g H)=0.1100 mol H/mL fuel (5)

Carbon:(0.7418 g C/mL fuel)(1 mol C/12.011 g C)=0.06176 mol C/mL fuel (6)

From these values, the maximum gas volumes at STP of CO and H₂ which can be derived by the partial oxidation of each mL of the diesel fuel is calculated:

H₂:(0.1100 mol H/mL fuel)(1 mol H₂/2 mol H)(22,414 mL H₂/mol H₂)=1233 mL H₂/mL diesel fuel (7)

CO:(0.06176 mol C/mL fuel)(1 mol CO/1 mol C)(22,414 mL CO/mol CO)=1384 mL CO/mL diesel fuel (8)

In the case of steam reforming, the volume of CO is the same as in dry direct partial oxidation: 1384 mL CO/mL diesel fuel, but the H₂ derived from the water provides an additional 1384 mL H₂/mL diesel fuel for a total of 2617 mL H₂/mL diesel fuel. Therefore, each mL of liquid diesel fuel produces considerable volumes of gaseous fuel for solid oxide fuel cells. A total of 2617 mL min⁻¹ of syngas is produced for each mL of liquid diesel fuel in the case of dry direct partial oxidation. A total of 4,001 mL min⁻¹ (4.00 L min⁻¹) of syngas can be produced per mL of liquid diesel fuel by pure steam reforming. A summary of calculations along with expected H₂ and CO production for 0.05 mL/min diesel used in catalyst testing is shown in Table 3. From the last column in Table 3, the total volume of CO+CO₂+CH₄ should add up to 69.25 mL min⁻¹ for 0.05 mL min⁻¹ of diesel fuel injected into the system. If this was the case, then it was concluded that 100% of the diesel fuel was reformed. If the sum was a fraction of this, then it was assumed that part of the fuel was unreformed, likely exiting the reactor as aromatic compounds.

TABLE 3
Summary of Calculations from the Analysis
of the Commercial Diesel Fuel

| Element | H | C |
|---|---|---|
| Mass % | 13.00 | 87.00 |
| moles/100 g Fuel | 12.90 | 7.24 |
| g/mL Fuel | 0.111 | 0.742 |
| moles/mL Fuel | 0.1101 | 0.0618 |
| Max. Production by | 1233 | 1384 |
| Partial Oxidation | | |
| mL gas/mL fuel | | |
| Max Production by | 2617 | 1384 |
| Steam Reforming | | |
| mL gas/mL fuel | | |
| Max. Production by | 61.70 | 69.25 |
| Partial Oxidation | | |
| mL gas/0.05 mL fuel | | |
| Max. Production by | 130.95 | 69.25 |
| Steam Reforming | | |
| mL gas/0.05 mL fuel | | |

### IV. Optimization of Catalysts.

For perovskites of general formula, A′₁₋ₓA″ₓB′_{1-y}B″_{y}O_{3-δ} elements at the A′ sites were varied between La and Y, those at the A″ sites were varied between Ca, Sr, and Ba, and those at the B′ and B″ sites were varied between Co, Fe, Mn, Ru, Ce and Mo. In the general formula, 0<x<1, 0<y<1, and δ=represents the moles of oxygen vacancies in the oxide crystal lattice. The value of 6 is typically near 0.3, but is not limited to 0.3. Catalyst supports were varied between MgO and 8 mole % YSZ. Some perovskites of one formula were also tested as supports for perovskites of a second formula. The test results indicated that the yttria-stabilized zirconia was superior to the magnesia and perovskites as a support. The yttria-stabilized zirconia retained reasonable porosity after extended use at 1000° C. under diesel fuel reforming conditions, retained its crystal structure, and did not form sulfides or other compounds. Mobility of oxygen in the zirconia lattice may also favor partial oxidation by metal-support interactions relative to MgO, which has limited oxygen mobility at 1000° C. Zirconia catalyst supports used in a fuel reformer will also be compatible with zirconia used in solid oxide fuel cells.

Perovskite catalysts of general formula, La₁₋ₓAₓBO_{3-δ} were optimized by substituting various quantities of Ca²⁺ and Sr²⁺ in the A-sites at various stoichiometries, x, and by substituting Co, Mn, Fe, Ru, and the like, into the B-sites. Supports were also varied between MgO prepared by different methods, yttria-stabilized zirconia oxide prepared by various methods and refractory perovskites. Deposition methods were also varied as was the use or disuse of pore formers.

Experimental conditions were set for testing relative catalyst merit by initially selecting a relatively high steam to carbon ratio for ease of carbon suppression. In the initial studies, in which many catalysts needed to be tested and compared for activity and stability, the expediency of using a high steam to carbon ratio was used. Superior catalysts found in this manner were later evaluated under dryer conditions. In the initial catalyst screening, a molar ratio of 4:1 steam to carbon was used to suppress carbon. In addition to steam, oxygen was fed into the reactors to simulate oxygen from an oxygen transport membrane. The oxygen flow rates were calculated to produce a 0.46 atomic oxygen to carbon molar ratio. Helium was used as a carrier gas during catalyst screening to rapidly transport fuel and oxygen to the catalyst bed in the reactor hot zone. Within the two inch hot zone of the furnace, the temperature variation was only ±5° C. of the set point value. Typically 15-20 g of catalyst was used.

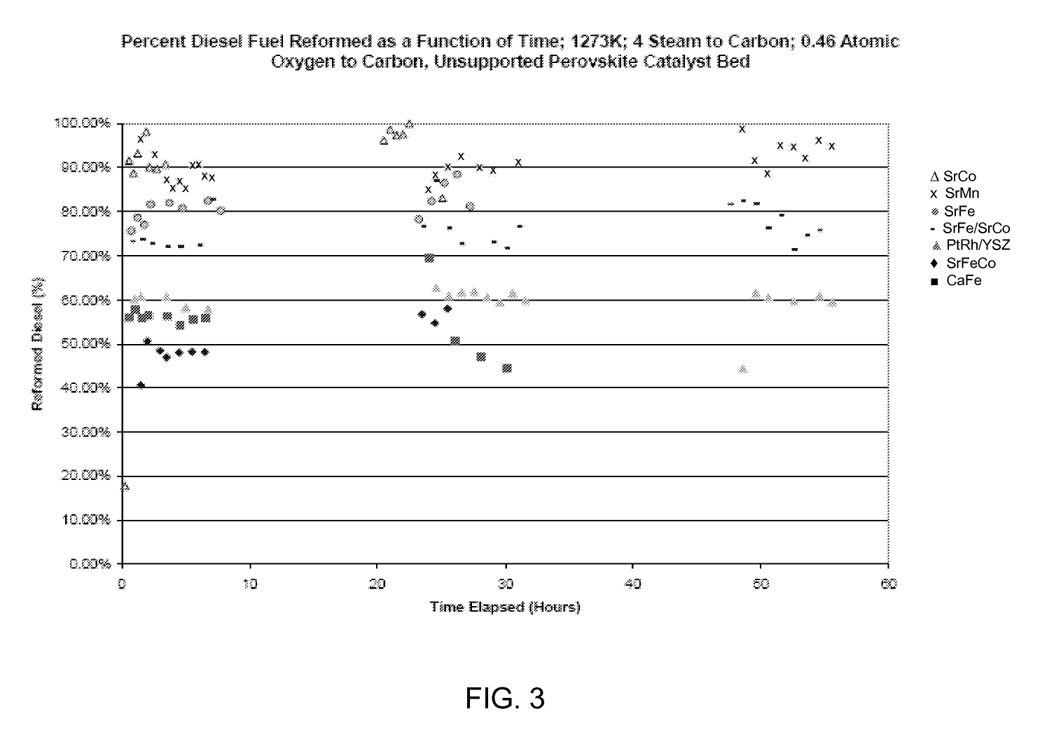

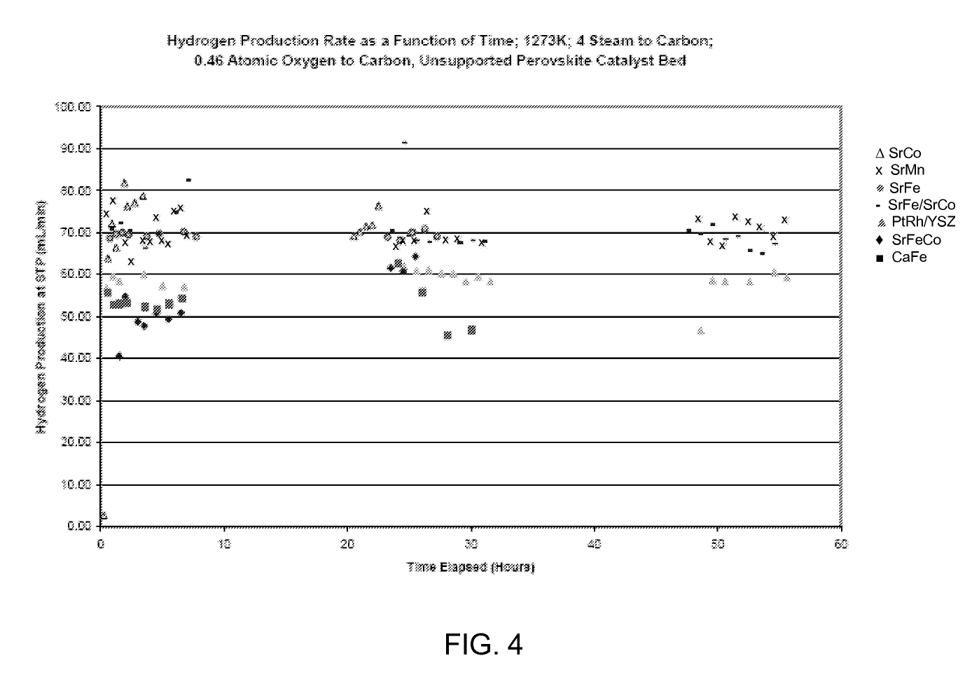

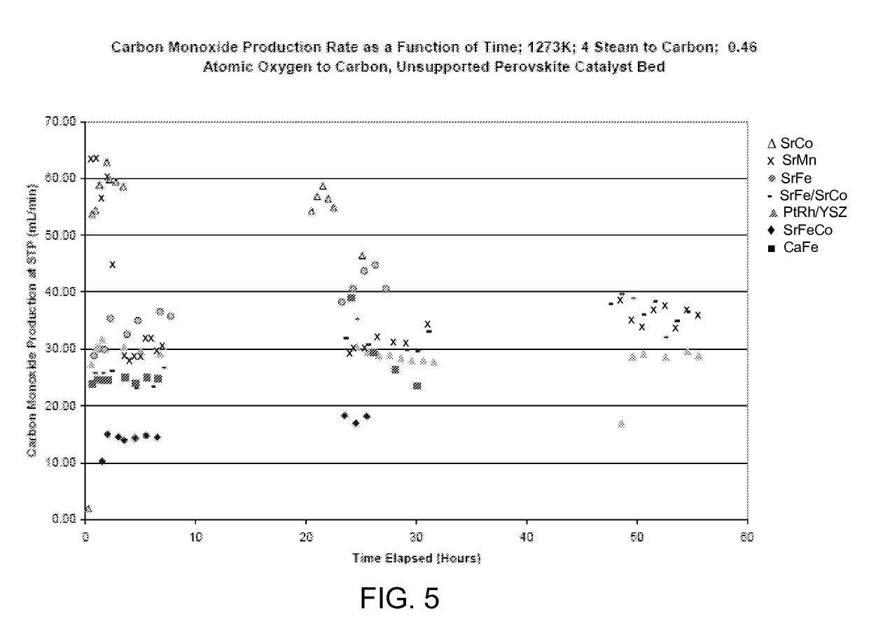

A partial list of catalysts made and tested is provided in Table 4. FIGS. 3-8 summarize the performance of a group of catalysts tested. In addition to those listed, Pt—Rh supported catalysts and superior perovskite catalytic materials were coated onto MgO, 8 mole % yttria stabilized zirconia, or perovskite porous supports. The Pt—Rh metal dispersed onto YSZ was used to establish a performance baseline to which the perovskite-based catalysts could be compared.

TABLE 4
Representative Catalysts Formulated and Tested

| Code | Composition |
|---|---|
| SrFe | La₁₋ₓSrₓFeO_{3-δ} |
| SrCoMn | La₁₋ₓSrₓCo_{1-y}Mn_{y}O_{3-δ} |
| SrFeCo | La₁₋ₓSrₓFe_{1-y}Co_{y}O_{3-δ} |
| CaFe | La₁₋ₓCaₓFeO_{3-δ} |
| SrFeRu | La₁₋ₓSrₓFe_{1-y}Ru_{y}O_{3-δ} |
| BaCeY | BaCe_{1-y}Y_{y}O_{3-δ} |
| BaCeCo | BaCe_{1-y}Co_{y}O_{3-δ} |
| BaCeFe | BaCe_{1-y}Fe_{y}O_{3-δ} |
| SrCo | La₁₋ₓSrₓCoO_{3-δ} |
| SrMn | La₁₋ₓSrₓMnO_{3-δ} |
| CaCo | La₁₋ₓCaₓCoO_{3-δ} |

La₁₋ₓSrₓCoO_{3-δ}. Initial activity of unsupported porous La₁₋ₓSrₓCoO_{3-δ} (see FIG. 3, SrCo) was excellent, reforming 90-100% of the diesel fuel feed using only 15-20 g of catalyst. However, after 50 hours of continuous use, the catalyst bed became plugged. Post reactor x-ray diffraction of the spent catalyst revealed that the perovskite decomposed into metallic cobalt, SrO and La₂O₃. From previous research, it was known that La₁₋ₓSrₓCoO_{3-δ} decomposes under highly reducing conditions, producing highly dispersed elemental cobalt on a support of acidic La₂O₃ neutralized by basic SrO. This is one method used to disperse cobalt and to minimize acidic sites on La₂O₃. Behavior of La₂O₃ is somewhat similar to that of Al₂O₃. However, SEM images revealed that at 1000° C., the cobalt agglomerated into large (<1 micron diameter) spheres, greatly reducing cobalt surface area. The unsupported porous perovskite catalyst disintegrated into a powder, which led to plugging of the catalyst bed. Although the porous La₁₋ₓSrₓCoO_{3-δ} catalyst might have potential for use at lower temperatures, or under conditions in which partial pressures of oxygen are higher, a temperature of 1000° C. appears to be too extreme for unsupported porous La₁₋ₓSrₓCoO_{3-δ} under these reducing conditions.

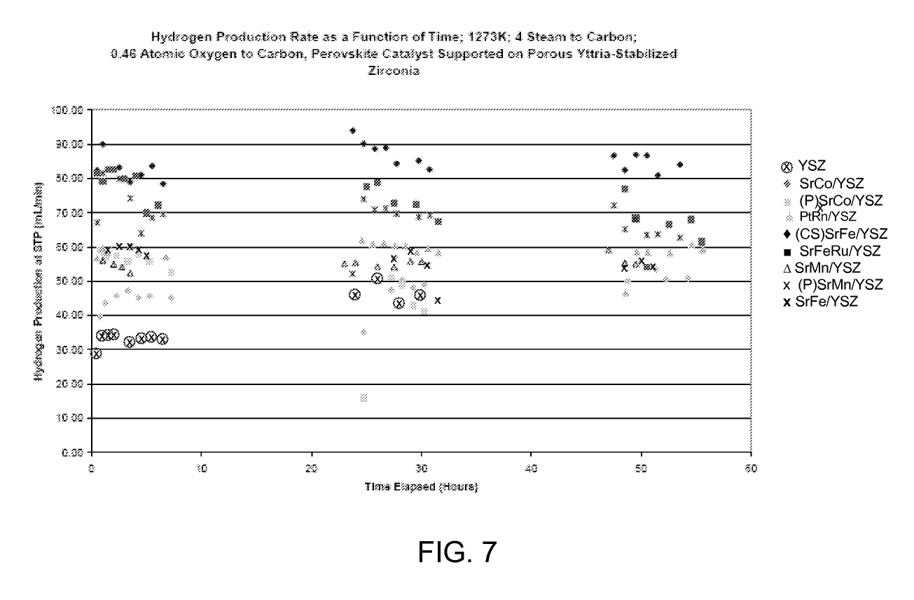

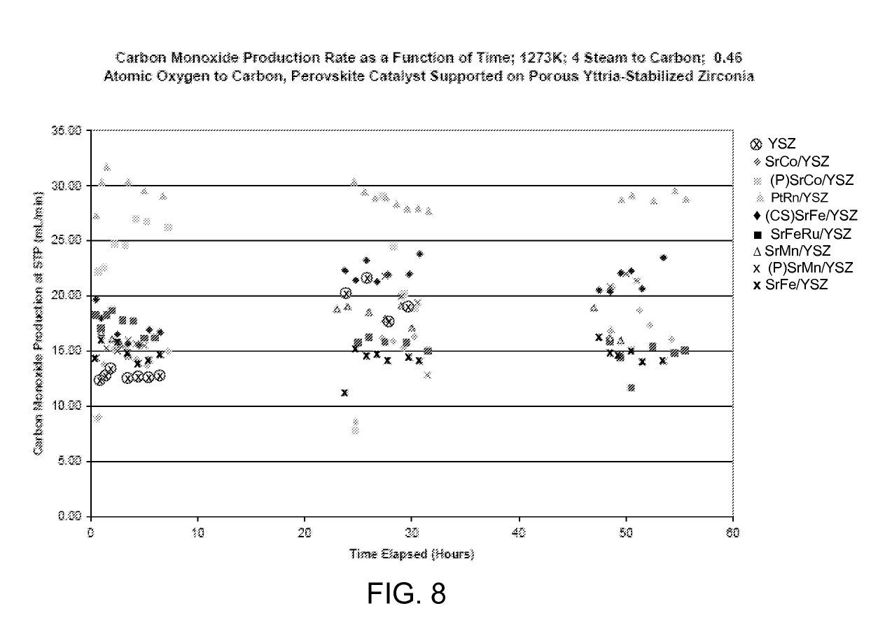

La₁₋ₓSrₓCoO_{3-δ} Coated onto Porous Supports. Because of the high initial activity of La₁₋ₓSrₓCoO_{3-δ}, testing was continued using La₁₋ₓSrₓCoO_{3-δ} supported on MgO, yttria-stabilized zirconia and other, more stable perovskite supports. As shown in FIGS. 7 and 8, for catalysts labeled with cobalt, Co, the overall performance of supported La₁₋ₓSrₓCoO_{3-δ} did not match the performance of the unsupported porous La₁₋ₓSrₓCoO_{3-δ} in these preliminary studies. The best combination was La₁₋ₓSrₓCoO_{3-δ} supported on a second stable perovskite. However, the activity of this combination declined after 120 hours continuous use. SEM analysis of the La₁₋ₓSrₓCoO_{3-δ} supported on a second porous, stable perovskite showed that the metallic cobalt again agglomerated into micron-size beads on the surface of the ceramic. Again, a temperature of 1000° C. may be too extreme for cobalt-based catalysts, considering its relatively high vapor pressure and likely high rate of surface migration. The supported La₁₋ₓSrₓCoO_{3-δ} catalysts might find application at lower operating temperatures.

In addition to the solid-state powder coating, YSZ support was coated with La₁₋ₓSrₓCoO_{3-δ} polymer precursor made by the Pechini method. The Pechini coated material, expected to produce the highest dispersion, showed the highest overall initial performance, but after just 30 hours of continuous testing saw a large drop in performance. Post reactor analysis showed that the majority of the catalyst coating had either sintered badly or had not adhered well to the YSZ support.

La₁₋ₓSrₓMnO_{3-δ}. Initial activity of porous La₁₋ₓSrₓMnO_{3-δ} was very good, reforming nearly 90% of the diesel fuel in the feed. However, like the porous La₁₋ₓSrₓCoO_{3-δ}, the catalyst bed eventually plugged. As with La₁₋ₓSrₓCoO_{3-δ}, the La₁₋ₓSrₓMnO_{3-δ} is expected to decompose under these harsh reducing conditions, forming a highly dispersed Mn-based catalyst supported on SrO—La₂O₃. The catalyst disintegrated into fine powder, which plugged the reactor. Manganese may also form a sulfide under reaction conditions.

La₁₋ₓSrₓMnO_{3-δ} Coated onto Porous Supports. La₁₋ₓSrₓMnO_{3-δ} powder and Pechini precursor polymers were coated onto YSZ porous support material. Both supported La₁₋ₓSrₓMnO_{3-δ} materials had good initial activity as with the unsupported porous catalyst, but disintegration to fine powder eventually plugged the reactor.

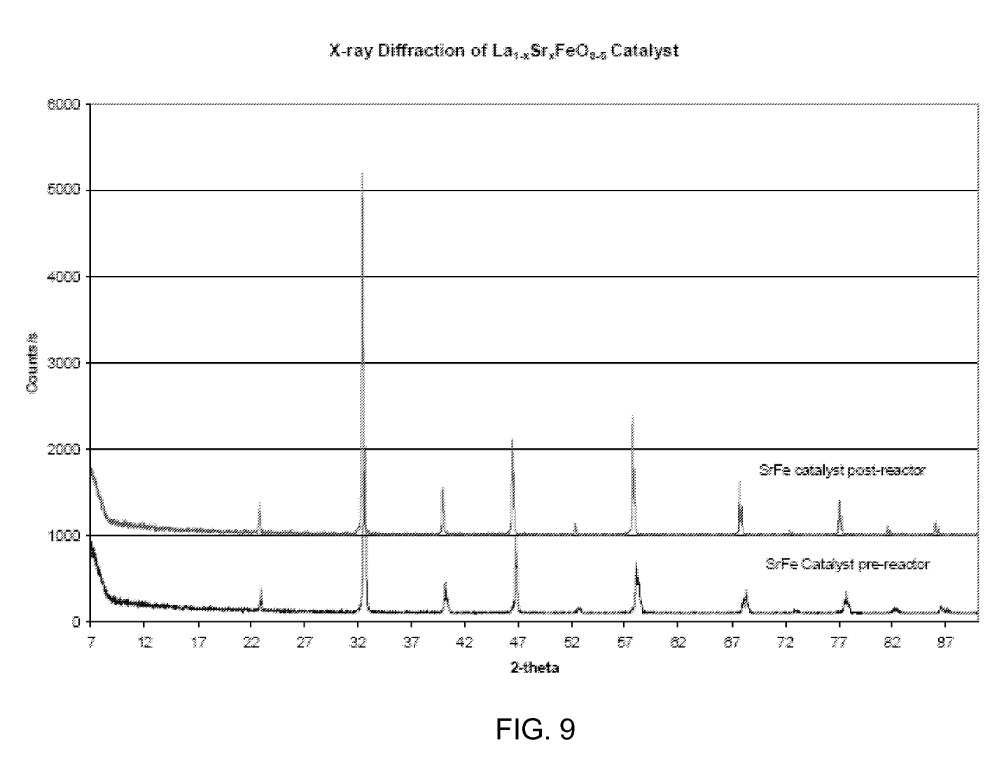

La₁₋ₓSrₓFeO_{3-δ} Initial activity of the unsupported porous La₁₋ₓSrₓFeO_{3-δ} was very good, reforming nearly 80% of the diesel fuel feed with only 15-20 g of catalyst in the reactor (see FIG. 3 SrFe). Moreover, synthesis gas production remained relatively stable over the 200 hours continuous operation of the experiment, and there was no evidence of coke or plugging of the catalyst bed. X-ray diffraction showed that this material remained single phase and retained the perovskite structure after testing in the reducing atmosphere in the reactor (FIG. 9).

La₁₋ₓSrₓFeO_{3-δ} on Porous Supports. Dense and porous solid-state catalyst powder of La₁₋ₓSrₓFeO_{3-δ} was coated onto various porous support material. Dense coatings were deposited onto both porous YSZ and porous MgO. The MgO coated catalyst plugged in less than 30 hours. The dense coatings on YSZ reformed approximately 30% less diesel fuel than the unsupported porous catalyst beds. SEM images post reactor showed a relatively dense coating implying that limited surface area likely adversely affected activity.

To increase surface area of the supported La₁₋ₓSrₓFeO_{3-δ} on YSZ, cornstarch pore former was added to the catalyst slurry. The porous catalyst coating showed a 10% activity increase over that of the dense catalyst coatings of the same composition. However, the porous coated catalyst did not achieve the high initial activity of the unsupported, porous catalyst bed of La₁₋ₓSrₓFeO_{3-δ}. However, long term tests of La₁₋ₓSrₓFeO_{3-δ} on YSZ showed very stable activity for 1400 hours (two months) of testing.

0.3 wt % Pt, 0.3 wt % Pt and Rh. Noble metals were dispersed onto porous YSZ using platinum nitrate and rhodium chloride precursors dissolved in de-ionized water. Using a Roto-vap, the porous supports, saturated with the salts, were heated to 80° C. under vacuum, and the water was evaporated. The supports, coated with the dried material, were heated in a reducing atmosphere, 5% H₂/Ar, to 500° C. for 2 hours. The supported noble metal catalysts were used as a base-line for comparison to the less expensive perovskite-based catalysts.

As expected, initial catalytic activity of the supported noble metals was good, reforming nearly 60% of the diesel fuel in the feed (see FIG. 3). At 1000° C., bulk sulfides of these noble metals are not expected to be stable, and poisoning by sulfur should be less of an issue relative to use at much lower temperatures. However, performance started to decrease after 150 hours of continuous testing. These catalysts sintered at 1000° C. and lost the high surface area which was present in the initial dispersion. This a common problem using supported noble metal catalysts operated at 1000° C., and is also experienced by other researchers. Although Pt or Pt—Rh dispersed onto yttria stabilized ZrO₂ may be more suitable for use at lower temperatures (800° C.), the desired reforming temperature of 1000° C. may be too high for its practical long-term use.

La₁₋ₓCaₓCoO_{3-δ}. This calcium doped analog of La₁₋ₓCaₓCoO_{3-δ} was predicted to be more stable than La₁₋ₓCaₓCO_{3-δ}. However, x-ray powder diffraction showed that it was not stable enough to survive the harsh reducing conditions at 1000° C. The unsupported porous material initially reformed 60% of the diesel fuel, but after only 50 hours continuous use, the reactor tube became plugged as the catalyst disintegrated into fine powder.

La₁₋ₓSrₓCo_{1-y}Mn_{y}O_{3-δ}. This material, like the La₁₋ₓCaₓCoO_{3-δ} and La₁₋ₓSrₓMnO_{3-δ} material, decomposed at 1000° C. under the reducing conditions of the diesel fuel reformer. Testing of unsupported porous catalyst beds of this material reformed less than 50% of the diesel fuel feed. Plugging was unacceptable.

La₁₋ₓSrₓFe_{1-y}Co_{y}O_{3-δ}. Given the stability demonstrated for La₁₋ₓSrₓFeO_{3-δ} and given the high initial activity of most of the cobalt compounds, cobalt doped La₁₋ₓSrₓFeO_{3-δ} catalysts were fabricated and tested. The unsupported porous catalyst material, however, showed mediocre long-term performance. After only 25 hours of continuous use, the catalyst bed had begun to plug.

La₁₋ₓCaₓFeO_{3-δ}. The calcium doped analog of La₁₋ₓCaₓFeO_{3-δ} was synthesized and tested. Initially, the unsupported porous catalyst reformed 55% of the diesel fuel in the feed, but the catalyst eventually decomposed under the reducing atmosphere at 1000° C.

Doped Barium Cerates. Three doped barium cerates were also fabricated and tested: BaCe_{1-y}Y_{y}O_{3-δ}, BaCe_{1-y}Co_{y}O_{3-δ}, and BaCe_{1-y}Fe_{y}O_{3-δ}. These materials were not single phase, nor was it necessary for single phase to be present to form acceptable catalysts. These materials are well-known proton-conducting materials, and are good candidates for dehydrogenation/oxidation catalysts. Such materials were predicted to catalyze decomposition of hydrocarbons and to catalyze their oxidation. Unsupported porous catalyst beds of these materials reformed about 60% of the diesel fuel.

La₁₋ₓSrₓFe_{1-y}Ru_{y}O_{3-δ}. Literature of the group at Argonne National Laboratories (Liu and Krumpelt^{13,14}, and various website listings) reports that ruthenium has been used with success in doped perovskite catalysts, most notably in LaCrO₃. Ruthenium was doped into La₁₋ₓSrₓFeO_{3-δ} in an attempt to augment catalytic activity of this stable material. The material was combined with pore former and coated onto YSZ porous support. The fraction of diesel fuel reformed was 55%. This compound maintained the stability of the undoped La₁₋ₓSrₓFeO_{3-δ} compound. However, whereas addition of Ru apparently increases the catalytic activity of LaCrO₃, it had little effect on La₁₋ₓSrₓFeO—_{-δ}, apparently because of the superior inherent catalytic activity of Fe relative to Cr.

The catalyst screening and optimization studies can be summarized as follows: The most important factor influencing catalytic activity of the perovskite materials was their stability in a reducing atmosphere at 1000° C. La₁₋ₓSrₓCoO_{3-δ} and La₁₋ₓSrₓMnO_{3-δ}, known to decompose and to initially produce highly dispersed metals, were both initially extremely active, but their activity decreased with time. In the case of the cobalt compounds, agglomeration of cobalt into micron-sized spheres clearly limited catalyst surface area and led to catalyst deactivation at 1000° C. Disintegration of catalysts into fine powder and subsequent plugging of catalyst beds became a major issue. Of all the oxygen conductive materials which were tested, La₁₋ₓSrₓFeO_{3-δ} was, by far, the most stable catalyst. It was not the most initially active of the materials tested. However, it retained long-term (two months) activity. Although its rate of oxygen transport is lower than the other materials tested, this is compensated by its overall stability and retention of catalytic activity. This perovskite also formed a good support material for other perovskite catalysts.

Magnesium oxide was originally tested as the catalyst support material of choice because of its refractory nature and basic surface sites. However, 8 mole % yttria-stabilized zirconia, also expected to have basic surface sites, proved to be superior to MgO. Yttria-stabilized zirconia also has the ability to transport oxygen at 1000° C., which is an attractive feature for an oxidation catalyst. Although some interdiffusion of the elements in the yttria-stabilized zirconia and perovskite materials can occur at 1000° C., as in solid oxide fuel cells, reaction at the support/catalyst interface does not appear to affect catalyst activity occurring at the catalyst-gas interface. Undoped supports of MgO are expected to have negligible capability for oxygen transport under the desired reforming conditions (although, theoretically, doping with 1+ ions might create oxygen vacancies in MgO). Yttria-stabilized zirconia was selected for further tests as a catalyst support because of its reasonably high thermal and chemical stability, and for its compatibility with solid oxide fuel cells based on yttria stabilized ZrO₂ electrolytes.

Considering the thermodynamic analysis summarized in FIG. 2, it is predicted that CO₂, H₂O and CH₄ should be negligible at 1000° C. if the system is brought to equilibrium. However, the thermodynamic analysis predicts that considerable CO₂, H₂O and CH₄ could form in the cool zones of the reactor as the syngas leaves the hot zone of the catalyst bed and enters the reactor exhaust. The reactor tube used in the catalyst tests was of INCONEL, an alloy of 72% nickel, with iron and chromium. These metals have the potential to catalyze formation of CO₂, H₂O and CH₄ from the syngas, H₂+CO.

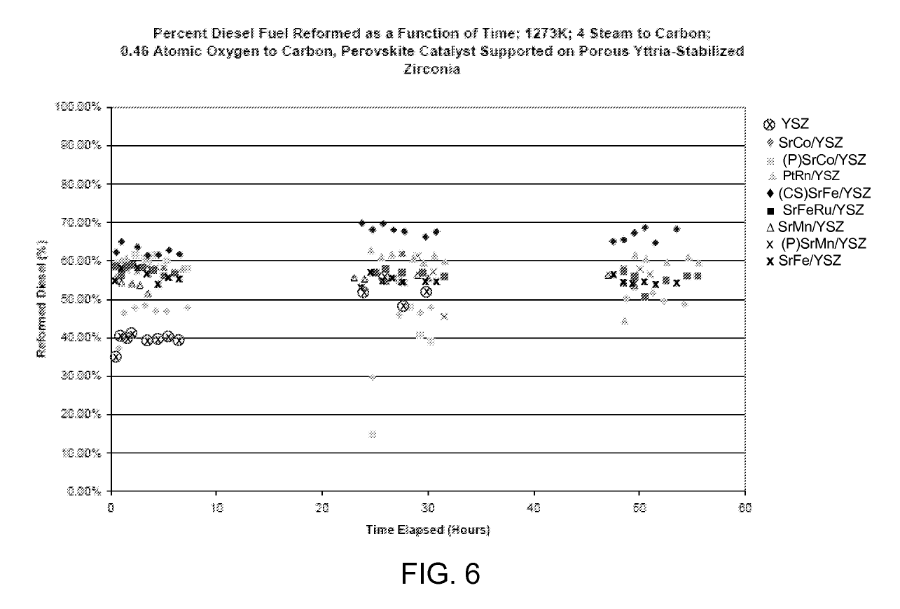

Therefore, in these preliminary tests, it is difficult to absolutely assign selectivity of the catalysts under test exclusively to the catalysts or to possible reactions on reactor walls in the cooler exhaust. Nevertheless, the results showed good selectivity in favor of CO. For example, in a preferred catalyst of La₁₋ₓSrₓFeO_{3-δ}, which reformed approximately 80% of the diesel fuel, the selectivity was 71.5% CO, 17.8% CO₂ and 10.7% CH₄. Some of the lack of selectivity is attributed to reactions in the cool zones of the walls, as evidenced by control experiments showing some activity in the empty reactor for the water-gas shift reaction: CO+H₂O=CO₂+H₂. In fact, the industrial water-gas shift catalyst is Fe₃O₄/Cr₂O₃, which is to be expected on the INCONEL walls. Such iron catalysts are reasonably tolerant to sulfur. The reaction: CO+3H₂=CH₄+H₂O is also favored at lower temperatures. Selectivity is expected to be improved with the use of inert ceramic wall materials. It should also be noted that, in this series of preliminary tests, the purpose was to compare relative activities and stabilities of about 40 catalyst formulations under identical reaction conditions. The catalyst bed size, catalyst mass, bed geometry, space velocity and residence time, catalyst pore size and total volume, catalyst granule size and catalyst pellet geometry of each catalyst was not optimized in these preliminary tests. The percent conversions discussed above and shown in FIGS. 3 and 6 provide data for relative activity as an aid to selecting the superior catalyst formulations.

### V. Demonstration of Long-Term Stability of Catalysts.

The long term stability of preferred catalysts for steam reforming of diesel fuel at 1000° C. which were identified as described above was examined. A two-month test at a temperature of 1000° C. was deemed a reasonable time to demonstrate catalyst stability in a nine-month project. Actual pump-grade diesel fuel, and not easy-to-reform surrogates, were deemed essential to demonstrate catalyst viability. Steam reforming, rather than dry direct partial oxidation was used as an expediency for suppressing carbon deposition on reactor walls in cool zones in initial testing. In brief, from the results of these tests it was found that a catalyst formulation using La₁₋ₓSrₓFeO_{3-δ} supported on yttria stabilized zirconia held steady diesel fuel reforming activity throughout the two-month test period. About 60% of the diesel fuel was reformed using only 15 grams of catalyst in the catalyst bed. Space-flow velocity, catalyst bed size, pellet geometry, and other parameters, were not optimized to obtain full conversion in the stability test. Post analysis of the catalyst granules showed finely dispersed Fe-based crystallites on the porous yttria stabilized zirconia. Iron, as expected, did not form a sulfide at the operating conditions. The zirconia retained good porosity, and x-ray powder diffraction showed that its crystal structure had not changed after 1,400 hours at 1000° C. in the diesel fuel reformer.

More specifically, initial screening of catalysts was conducted over periods of 50-120 hours (2-5 days) under continuous diesel fuel reforming conditions at 950-1000° C. It should be noted that actual commercial (sulfur-contaminated) diesel fuel straight out of the automotive pump was used in all experiments and not easy-to-reform surrogates often reported in the literature. Although operation at 1000° C. under sulfur-contaminated conditions for 2-5 days is not a trivial accomplishment, it was recognized that much longer testing periods would be required to demonstrate convincing long-term viability of the partial oxidation catalysts. Accordingly, a continuous two-month test at 1000° C. under actual diesel fuel reforming conditions, using the optimized catalyst, was devised to provide a severe test to demonstrate the long-term stability of the catalyst.

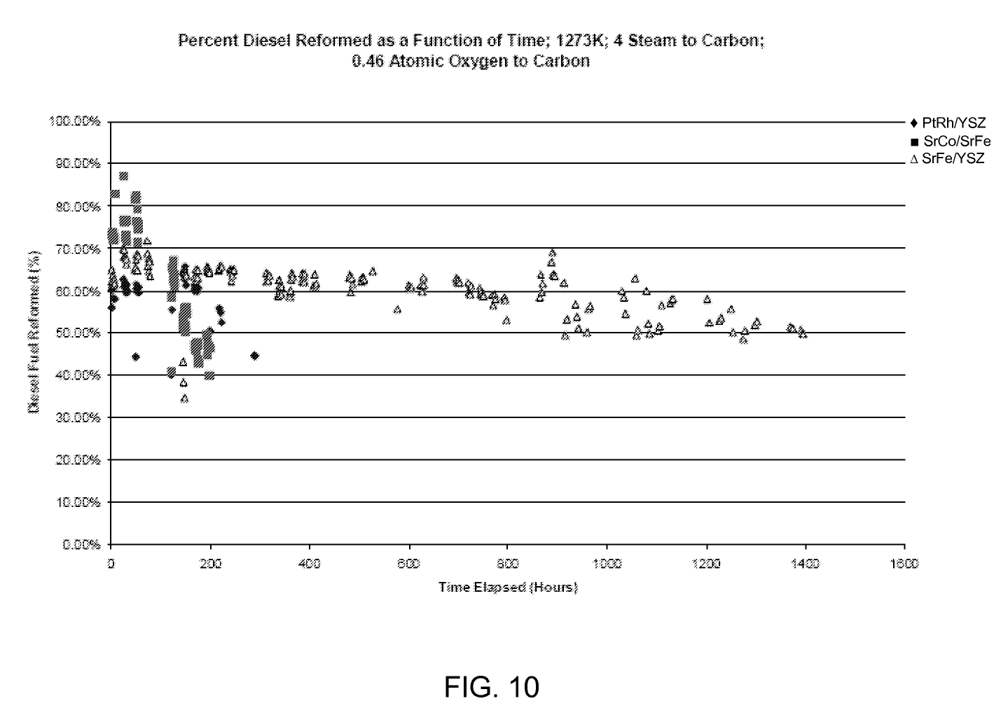

For expediency, steam was used to suppress deposition of carbon in the cool zones of the reactor. A molar ratio of 4:1 steam to carbon was used. In addition to steam, oxygen was fed into the reactor to simulate part of the oxygen which would be provided by an oxygen separation membrane. The oxygen flow rates were calculated to produce a desired 0.46 atomic oxygen to carbon molar ratio. Helium was used as a carrier gas to quickly inject the fuel into the hot zone of the reactor. An yttria-stabilized zirconia porous support coated with a porous La₁₋ₓSrₓFeO_{3-δ} catalyst was selected for the long-term experiment. Continuous testing at 1000° C. for 1400 hours (two months) was achieved with fairly stable overall activity (see FIG. 10). This material maintained a 50-60% diesel reforming efficiency for two months using only 15-20 g of catalyst. The catalyst was not optimized with respect to porosity, bed size, spare velocity, granule and pellet geometry, and other applicable catalyst/process variables. The results obtained in the present series of tests, using steam to suppress carbon formation, are considered predictive to at least some extent of the usefulness of a test catalyst in a process in which the reactor walls are capable of effusing and diffusing dry oxygen to suppress carbon deposition in the reactor cool zones, without the addition of steam to the process.

### VI. Analysis of Long-Term Test Catalyst (Post Reactor).

X-ray diffraction analysis was done on the catalyst which was held continuously at 1000° C. for 1400 hours (two months) and used to reform pump-grade D-2 diesel fuel. (The same catalyst for which data is shown in FIG. 10). All of the main peaks could be assigned to the yttria-stabilized zirconia catalyst support. As might be expected from solid oxide fuel cell research, the zirconia is stable at 1000° C. under the harsh reducing conditions. Very small peaks near 29° and 32° are assigned to La₂O₃ and La₁₋ₓSrₓFeO_{3-δ}, respectively.

Scanning electron microscope images were taken of catalyst granules after 1400 hours in the reactor. Porosity appears to have been maintained. X-ray spectroscopy indicates regions rich in iron, which was the transition metal used in the perovskite preparation. The iron-rich nodules are likely main sites of catalytic activity. The SEM analysis found that the samples did not charge during analysis. This is significant because it implies that the surfaces of the zirconia granules are electron conducting. Fresh, uncoated yttria stabilized zirconium granules are highly insulating and charge when viewed in the scanning electron microscope. Electron conduction is desired for electron transfer reactions.

From the X-ray spectroscopy analysis, it appears that much of the lanthanum and strontium has diffused into the zirconium. This might also be expected based upon interaction between perovskite-based electrodes and zirconia electrolytes in solid oxide fuel cells. Iron, expected to be fairly insoluble in zirconia, has remained on the surface. The iron-based perovskite catalyst may be similar to the cobalt and manganese based catalysts, in that it has decomposed to produce a well dispersed metal catalyst. Unlike cobalt, which appears to be too volatile at 1000° C. and which evaporates, and Mn, which may be poisoned by sulfur, the iron appears to have remained in place on the surface of zirconia and has remained catalytically active. Ellingham diagrams imply that sulfides of iron should not form under these reaction conditions. As a side note, the catalyst surface appeared to have picked up some molybdenum and chromium evaporated from the INCONEL alloy of the reactor. In hind sight, the INCONEL 625 alloy is a volatile source of metals, possibly transported as carbonyls, considering the high temperatures and high concentration of CO. The molybdenum could possibly influence the catalytic activity, especially considering that molybdenum is a good hydro-desulfurization catalyst. Chromium has also been used with fair success in perovskites by the group at Argonne National Laboratories.^{13,14} As is the case with most catalysts, it may be difficult to ascertain the exact active species on the surface. Nevertheless, the stable activity shown in FIG. 10 is the final arbiter of a catalyst's worth.

### VII. Use of CO₂ to Suppress Deposition of Carbon.

It is proposed that re-circulation of CO₂ from fuel cell exhaust is a viable means of suppressing deposition of carbon in fuel reformers. The oxygen in CO₂ increases the O:C atomic ratio in the system, which thermodynamically disfavors formation of graphite. A series of tests were carried out, and from the results it was found that, as predicted, addition of CO₂ does suppress deposition of carbon, allowing steam concentration to be reduced to 0.25:1 steam to carbon in the system. Preferred catalysts may allow the reverse Boudouard reaction: CO₂+C=2CO, as evidenced by increased CO production with increased CO₂ in the system, along with partial reduction of CO₂ by hydrogen to CO.

More specifically, re-circulation of steam and CO₂ from fuel cell exhaust was simulated in a series of tests, to determine the feasibility of the option of suppressing deposition of carbon with H₂O and CO₂. Although reaction of H₂O and CO₂ with carbon, H₂O+C=H₂+CO and CO₂+C=2CO (reverse Boudouard reaction), are net endothermic, re-circulation of fuel cell exhaust my still be one viable method for suppressing deposition of carbon in fuel reformers. In order to be viable, a necessary criterion is that catalysts must be capable of dissociating both H₂O and CO₂. Experiments were conducted using 8 mole % yttria-stabilized zirconia porous support coated with porous La₁₋ₓSrₓFeO_{3-δ}. Tests were initiated under the same conditions as used in the screening tests. A molar ratio of 4:1 steam to carbon was used to start the tests. Oxygen was fed into the reactor to simulate the necessary oxygen from an oxygen separation membrane. The oxygen flow rates were calculated to provide a 0.46 atomic oxygen to carbon molar ratio. In this experiment, carbon dioxide was added to the feed stream to simulate re-circulation of carbon dioxide exhaust from a fuel cell.

As CO₂ flow was increased, there was an increase in carbon monoxide production, which demonstrates that CO₂ was dissociated by the catalysts. Hydrogen production decreased as steam concentration was lowered and as the steam reforming reaction became less predominant, and as some H₂ reacted with CO₂. Comparison of CO₂ feed flow rates with CO₂ exhaust showed a net consumption of carbon dioxide at the higher concentrations of CO₂. In these tests, the steam to carbon ratio was lowered from 4:1 to 1:1. There was no coking or plugging observed upon lowering of the steam to these levels, demonstrating that CO₂ could be used to suppress deposition of carbon and to replace steam, if so desired, using the new catalysts.

### VIII. Addition of Oxygen to Deter Carbon Deposition.

Thermodynamic modeling shows that a minimum ratio of 1.02:1 moles oxygen atoms to moles carbon atoms is needed to fully suppress carbon formation at 1000° C. From the results obtained from the analysis of the diesel fuel showing that there is 0.0618 mol C/mL fuel, a total oxygen flow needed to suppress carbon without the presence of steam was calculated for a diesel fuel flow rate of 0.05 mL/min:

(0.05 mL fuel/min)(0.0618 mol C/mL fuel)(1.02 mol O/mol C)(1 mol O₂/2 mol O) (22,414 mL O₂/mol O₂)=35.32 mL O₂/min at STP (9)

Oxygen was slowly increased while reducing the steam flow. A steady-state was established with a ratio of 1.02:1 oxygen atoms to carbon atoms in the reactor. (A small amount of steam was still used to help prevent coking in the vaporizer). The steam to carbon ratio was reduced to approximately 0.25:1 without deposition of carbon. As molecular oxygen was increased and steam was decreased, production of carbon monoxide steadily increased, and carbon dioxide production decreased. This might imply that the water-gas shift reaction, CO+H₂O=CO₂+H₂, was formerly occurring in the cool zones of the reactor exhaust on the INCONEL walls. Otherwise, one would expect more deep oxidation to CO₂ as oxygen is increased. This is also used as evidence that increased selectivity towards CO could be achieved by control of reactor walls in the cool zones of the exhausts. Once steady-state was achieved, nearly all the reaction taking place could be accounted for as due to dry partial oxidation. The H₂/CO ratio produced was 0.83. This is very near the ideal H₂/CO ratio of 0.89 expected for dry pure partial oxidation of the diesel fuel and very far from the ratio of 1.89:1 predicted for pure steam reforming. This ratio is below the predicted value because loss of hydrogen occurs due to deep oxidation to water.

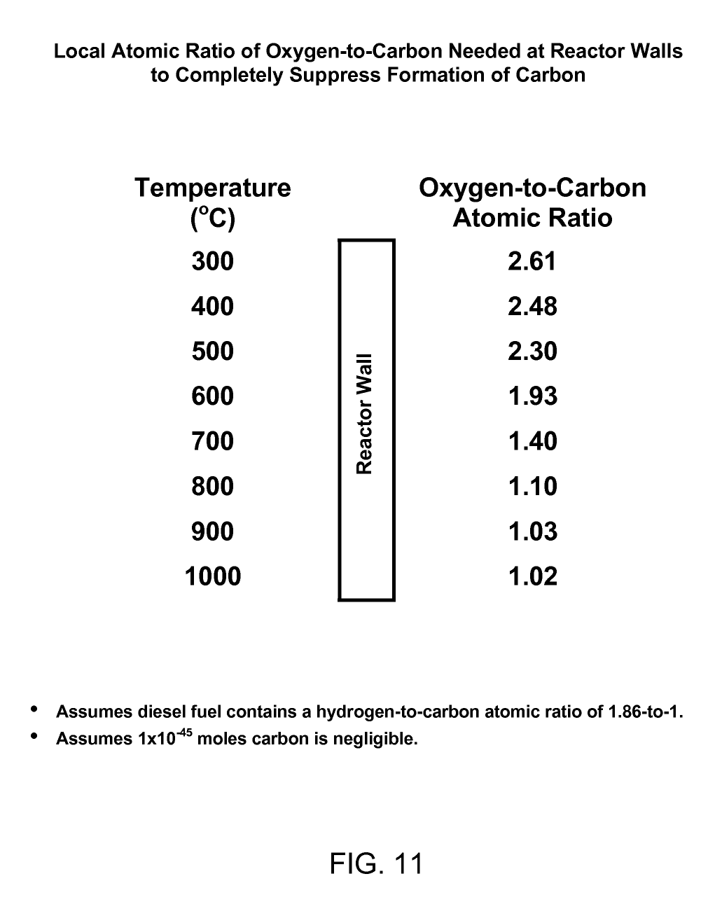

This steady state was maintained for 343 hours (14.3 days), with no problems of coking or plugging in the reactor. As expected, addition of pure oxygen to the system by directly mixing pure oxygen over porous catalyst beds suppressed deposition of carbon, which allowed reduction of added steam in the feed to a ratio of 0.25 steam to 1 carbon. This experiment showed that steam could be almost eliminated by replacement with oxygen. These studies establish the feasibility of providing oxygen by membrane walls, as described below with respect to the design of a reforming reactor, by simulating the provision of oxygen through reactor walls to suppress carbon. FIG. 11 illustrates the local atomic ratio of oxygen-to-carbon that is needed at the reactor walls to completely suppress formation of carbon. These ratios are based on the assumption that diesel fuel contains a hydrogen-to-carbon atomic ratio of 1.86:1, and that 1×10⁻⁴⁵ moles carbon is negligible. It is expected that dry partial oxidation can be performed using suitable porous catalytic wall materials, especially perovskites coated onto yttria stabilized zirconia.

### IX. Results of Catalyst Development and Optimization Studies.

In the above-described studies, low-cost catalysts were developed and optimized for use as a substitute for expensive noble metal catalysts. Preferred catalysts are stable to at least 1000° C. and capable of reforming commercial diesel fuel (as-received, out-of-the-pump containing ˜200 ppm (by mass) sulfur) into a mixture of synthesis gas (H₂+CO). The optimal catalysts identified during catalyst development are useful both in catalyst beds and on the walls of the reactors to partially oxidize carbonaceous feedstocks, preferably diesel fuel or JP-8. The catalysts are also useful as oxygen transport membrane materials and oxidation catalysts for suppression of carbon deposition on reactor walls.

More specifically, over 40 distinct catalyst batches were formulated and tested at 1000° C. for reforming commercial diesel fuel as-received out of the automotive pump, containing approximately 200 ppm (by mass) sulfur. Data for the best 24 are summarized in FIGS. 3-6. In one class of catalyst, perovskite-based catalyst powder was synthesized and the micron-to-submicron size powder pressed and sintered into porous catalyst granules and pellets.

One strategy tested was to use perovskite starting materials such as La₁₋ₓSrₓCoO_{3-δ} and La₁₋ₓSrₓMnO_{3-δ} which are known to decompose but which produce highly dispersed Co and Mn metal, respectively, supported on SrO—La₂O₃. The La₂O₃ behaves in many respects like the well known catalyst support, Al₂O₃. The cobalt catalyst initially reformed close to 100% of the diesel fuel (see FIG. 3), but after a few days of continuous operation at 1000° C., cobalt metal was found to agglomerate into large (micron-size) spheres. Also, few such spheres were observed, perhaps implying evaporation. This loss of cobalt and cobalt surface area led to decline in catalyst activity. It appears that 1000° C. is too severe for the cobalt-based catalysts, but the materials might find application at lower temperatures.

Likewise, La₁₋ₓSrₓMnO_{3-δ} showed very high initial activity for the first 50 hours, reforming 90-100% of the diesel fuel (see FIG. 3) into H₂, CO, CH₄ and CO₂ in which nearly all of the carbon entering the reactor in the diesel fuel could be accounted for in the CO, CH₄ and CO₂ products. Activity dropped for the Mn within one week at 1000° C. as the unsupported material disintegrated into fine powder. The catalyst might have potential if dispersed onto a stable support, but 1000° C. was also too severe for the Mn-based perovskite catalyst. Sulfur may also be a long-term issue for Mn. In a second strategy, perovskite catalysts were designed with reduced mobility for lattice oxygen, but with increased thermal and chemical stability. Pressed, sintered porous catalyst granules of the perovskite, La₁₋ₓSrₓFeO_{3-δ}, converted 80-90% of the diesel fuel for a catalyst bed containing only 15 grams of catalysts. X-ray diffraction indicated that this material was stable, retaining its perovskite crystal structure after use in the reformer.

Other pressed pellets of porous perovskite pellets reformed 60-80% of the diesel fuel (see FIG. 3). In all cases, the percent of diesel fuel reformed is based upon the carbon balance between the known mass of carbon entering the reformer as diesel fuel and the carbon detected as CO, CH₄ and CO₂.

In yet another strategy, perovskite catalysts were dispersed onto the refractory supports, magnesia (MgO) and 8 mole % yttria stabilized zirconia. Catalysts supported on 8 mole % yttria stabilized zirconia appeared superior, possibly due to increased mobility of lattice oxygen in the latter. FIG. 6 shows that most of the 8 mole % yttria stabilized zirconia supported catalysts reformed about 60% of the diesel fuel. Lack of very high dispersion may have limited activity relative to unsupported catalysts. The catalyst La₁₋ₓSrₓFeO_{3-δ}, supported on 8 mole % yttria stabilized zirconia retained its activity for two months at 1000° C. (see FIG. 10). However, in the presence of zirconia, the perovskite decomposes. The lanthanum and strontium apparently diffuse into zirconia, leaving active iron on the surface. Nevertheless, catalyst activity remained stable for 1400 hours (two months).

It was demonstrated that CO₂ could be used to suppress deposition of carbon and to replace steam. The data indicated that the catalysts decompose CO₂, which cannot remain thermodynamically stable at 1000° C. under the ratio of C:H:O used in the experiments. These catalysts would allow the option of re-circulating hot CO₂ from fuel cell exhaust to control carbon deposition in reformers. Steam can be replaced by oxygen to suppress deposition of carbon.

### X. Test Apparatus—Reforming Reactor Assembly for Testing Catalyst Compositions

In conjunction with the above-described development, testing and optimization of perovskite-type catalysts for reforming of diesel fuel, laboratory-scale reactor systems were constructed which could handle, measure and inject diesel fuel, heat catalysts to the desired 1000° C. reforming temperature, analyze the products (H₂, CO, and CH₄, as well as undesired CO₂) and to detect and confine noxious products, including H₂S, CO, diesel fumes and possible un-combusted polycyclic aromatic compounds. In addition, it was desired to have gas handling for injection of pure oxygen to simulate oxygen to be provided by oxygen transport membranes in a larger or commercial scale reactor, and to have gas handling systems for CO₂ and steam to simulate the possible option of re-circulating exhaust from solid oxide fuel cells into the reformer to suppress deposition of carbon. It was also necessary that the systems be fairly automated for long-term, unattended, continuous tests of up to two months. The systems also required methods for accurate temperature control and control of the flow of diesel fuel, steam, oxygen and CO₂ into the reactor, as well as measurement of exhaust flow to enable quantitative analysis of data for determination of catalyst activity.

For increased safety, a gas containment cabinet was constructed to surround the reactor system and to contain diesel fuel vapors, H₂S, COS, CO and other noxious gases. The gas containment cabinet was connected to a vent to exhaust gases. Monitors for detection of CO and H₂ were placed both inside and outside the gas containment cabinet to sound alarm in the event of a gas leak. Pressurized stainless steel vessels were used as reservoirs for both diesel fuel and water. The water supply served as a source of steam for the reactor. Pressurized helium gas was provided by commercial tanks of helium. The water and diesel reservoirs were provided with needle valves with metered Vernier handles, as are known in the art, for controlling flow of the liquids into reactor. A gas inlet was provided for feeding O₂, CO₂ and helium to the reactor. 316-type stainless steel tubing connected water and diesel supplies and O₂/CO₂/He inlet to a vaporizer and to the cool zone/mixing chamber. The vaporizer and mixing chamber were also made of 316-type stainless steel and were encircled with heating tapes to comprise a heating jacket.

An INCONEL sheathed thermocouple was located within the vaporizer chamber to work in combination with the heating tapes to control the pre-heat temperature of the reactants. The reactor tube was made of INCONEL Type-625 alloy. While this apparatus served well for short tests, INCONEL is not suitable as a long-term reactor wall material for extended use at 100° C. The inner diameter of the reactor tube was 20.9 mm and had a length of 457 mm. To support the catalyst bed a perforated INCONEL plate was held in place from beneath using an INCONEL tube. The perforated INCONEL plate was machined from a disk cut from INCONEL rod. A uniform array of holes, with diameter of ⅛ inch was drilled to form the perforated plate. The hot zone/heating zone contains granules or pellets of the catalyst being tested and would be subjected to the maximum or near maximum temperatures during operation of the reactor. A gas chromatography sampling port was inserted ahead of an exhaust vent. A desiccant (e.g., calcium sulfate, Drierite™) preceded the gas chromatography sampling port, to protect the gas chromatography column from water and possible unreacted diesel fuel.

In preliminary screening and evaluating the various oxygen anion-conducting oxides described in foregoing sections, some steam was used to initially suppress deposition of carbon. In subsequent studies, steam was largely removed and replaced with CO₂ or O₂, and it is expected that steam can be eliminated altogether for suppression of carbon in industrial scale operations by using reactor walls that effuse and diffuse oxygen. In these studies, the liquid storage tanks were pressurized to 10 psi using helium above the liquids. The pressurized liquid storage tanks allowed fuel and water to be forced through tubes with openings near the bottom of the tanks and to flow into the reactors. The pressurized tanks avoided the need for fuel-handling pumps. Needle valves with metered Vernier handles were used to control flow of the liquids into the reactors. Diesel fuel and water liquid flows for given needle valve settings were calibrated by measuring the mass of liquid expelled over time. Dry ampules were weighed before and after filling with liquid. Measurements were taken over the range of metered settings to produce calibration curves for liquid mass flow. The calibration curves allowed calculation of flows for the metered valve settings.

In operation, the diesel fuel and water feeds passed from the pressurized tanks through 316-type stainless steel tubing to the vaporizer and cool zone/mixing chamber prior to entering the reactor. The vaporizer and cool zone were heated to 280° C. using heating tapes. The vaporizer temperature was controlled using a thermocouple located within the vaporizer chamber. A pre-heating temperature of 280° C. was the highest that could be safely achieved without deposition of carbon in the vaporizer. Temperature measurements in the reactor tube indicated a 1000° C. hot zone of approximately 2 inches in length. Flow rates of the gases were controlled by rotameters. The rotameters were calibrated using a volumetric bubble meter for several rotameter settings. Flow rates measured at ambient pressure and temperature were converted to standard temperature and pressure, and calibration curves were created. A calibration curve was established for each gas. From exhaust outlet, the reacted gases flowed through a cold trap and then through the desiccant to protect the gas chromatography column by removing water and unreacted diesel fuel. The reactor exhaust was analyzed by gas chromatography. A Shimadzu model GC-14A gas chromatograph with an Alltech Carbosphere 80/100 column was used to analyze syngas products. The gas chromatography apparatus was calibrated using three different purchased (AirGas) standardization calibration tanks with varying known concentrations of hydrogen, carbon monoxide, methane and carbon dioxide. Gas chromatography peak areas for each gas were measured from each standardization tank, and a calibration curve for each gas was established.

### XI. Preparation of Perovskite Catalyst Powder for Inner Wall Fabrication.

Perovskite powders, which were demonstrated in the preceding sections to possess high, stable, catalytic activity for diesel fuel reforming, are used to coat the porous cylinders of yttria-stabilized zirconia to act as self-cleaning reactor walls of a reforming reactor. Suitable compositions of the perovskite powders are prepared from mixtures of metal oxides, such as La₂O₃ and Fe₂O₃, and, where appropriate, metal carbonates, such as SrCO₃ and CaCO₃.

Appropriate masses of dry powders of the inorganic starting materials are placed into polyethylene bottles with several cylinders of yttria-stabilized zirconia (YSZ) used as a grinding medium. Isopropyl alcohol is added to create slurries. The slurries are rotated in the bottles for several hours using a ball mill, to produce mixtures of the starting materials in close, intimate contact. Slurries are poured into evaporation dishes, and the isopropyl alcohol removed by evaporation.

Interdiffusion and solid-state reactions between starting materials are initiated by placing the dried slurries into alumina crucibles and firing in air to temperatures near 1200° C., or as appropriate. The materials are held for approximately twelve hours at the solid-state reaction temperature. Solid-state reaction products formed in this first step are re-ground and re-mixed to allow further intimate contact. The solid-state reaction procedure is repeated to allow the solid-state reactions to go to completion. The above procedure typically produces a single-phase perovskite product. Verification of complete reaction and the absence of starting materials and undesired side reactions may be obtained, if desired, using x-ray powder diffraction. If X-ray diffraction indicates incomplete reaction, the solid-state reaction temperatures is increased.

After synthesis, the perovskite materials are ground to 45 mesh and then subjected to attritor milling to produce a particle size distribution in the micron to submicron diameter range. About 1.5 lbs (0.68 kg) of 5 mm diameter, yttria stabilized zirconia spheres are placed into the attritor tank along with 100 g of the 45 mesh perovskite powder and 120 mL of isopropyl alcohol. The perovskite powder is subjected to attrition milling for approximately four hours. Desired particle size distribution is verified by laser diffraction, if desired. After attrition milling, the isopropyl alcohol is removed by evaporation, and the perovskite powder is then sieved to 170 mesh size.

Ceramic oxide powders with high catalytic oxidation activity, such as are mixed with appropriate pore formers and binders and then slurry coated onto the inside of porous zirconia tubes cylinders. For example, catalysts of general formula, La₁₋ₓSrₓFeO_{3-δ} are mixed with pore former and binder and then slurry coated onto the inner walls of the porous zirconia tubes. Preferably the entire length of the tubes is coated. Perovskite powder is mixed with cornstarch, as pore-former, and polyvinyl butyrate (PVB) as binder, in the ratio of 10:6:1, by mass. The mixture is placed into polyethylene bottles containing several cylinders of yttria-stabilized zirconia (YSZ). Acetone is added to create a slurry. The slurry is then rotated in the bottles for four hours on a ball mill, to produce an intimate mixture.

The slurry-coated cylinders are then heated in air at a rate of 1° C. min⁻¹ to burn away the pore formers and binders and to sinter the perovskite particles to the zirconia and to each other. The starch and binder are oxidized and burn away at approximately 300-400° C., (as determined by thermo-gravimetric analysis). Removal of the pore former and binder leaves an array of interconnected pores, occupying 35-40 percent by volume of the coating. This is usually sufficient to allow rapid effusion of air through the porous walls of the cylinders (at rates well over 100 mL min⁻¹ cm⁻²) if a differential pressure is applied across the walls. Heating continues to the perovskite sintering temperature, usually >1,200° C., dwelling at the sintering temperature for four hours, or as needed to produce a mechanically robust structure, without closing the pores. The sintered porous coated cylinders are then cooled at a rate of 1° C. min⁻¹ to room temperature.

Effusion rate of air through the walls of the cylinders may be measured at differential pressures of a few psi across the cylinder walls. The rate of effusion of air through the porous cylinders, first at room temperature, may be measured, if desired, using bubble-flow meters for smaller cylinders and rotary drum digital wet test meters or mass flow controllers for larger cylinders. Effusion may also be measured throughout the temperature range from ambient to 1000° C. by placing the cylinders within reactor tube ovens, and thermal stability throughout the desired temperature range may be verified. Porosity and sintering conditions may be further optimized to yield maximum effusion of air, while retaining practical mechanical strength of the coatings, if desired.

An estimate of the size of porous cylinders for a representative 5 kW diesel fuel reformer, is obtained by, first, assuming, that air, if not dry, will be required at a rate of 70 L min⁻¹ (70,000 mL min⁻¹ (STP)). For a cylinder of radius, r, of 3 cm (1.2 inch), for example, and an estimated effusion rate through the porous material of 100 mL min⁻¹ cm⁻², the height, h, of the porous cylinder is calculated from: πr²h=(70,000 mL min⁻¹)/(100 mL min⁻¹ cm⁻²). Solving for height, h, yields h=24.8 cm (9.7 inches). It can be readily appreciated that a self-cleaning porous perovskite cylinder for an inner wall liner of a fuel reformer cool zone could be quite compact. An effusion rate of air of 100 mL min⁻¹ cm⁻² was assumed for a very porous material. This should not be confused with the rate of diffusion of pure oxygen through a dense perovskite membrane material which might transport, at best, 10 mL min⁻¹ cm⁻² of pure oxygen at 1000° C. A flow rate of air of 100 mL min⁻¹ cm⁻² would provide a flow rate of molecular oxygen of approximately (0.20)(100 mL min⁻¹ cm⁻²)=20 mL min⁻¹ cm⁻².

Effusion of air through the porous perovskite walls depends upon pore size, interconnected pore volume, tortuosity, wall thickness, differential pressure and temperature. Ultimate porous cylinder geometric size may be adjusted to match the measured effusion rates with desired practical differential pressures across the porous walls. If a very compact cylinder is dictated by the reformer design, and if higher air flow is desired in a smaller cylinder size, then straight channels through the porous walls may be incorporated to increase the flow of air into the reformer. Channels are created using aligned combustible polymer fibers which span the walls of the green body and which are burned away and removed during the sintering process.

### XII. Fabrication of the Inner Wall of a Catalytic Membrane Reactor

Ceramic powders of yttria-stabilized zirconia are pressed into porous cylinders or tubes which are then coated with one or more suitable oxidation catalyst, as identified in the foregoing sections. The procedure for preparing perovskite powders is described above. The resulting rugged, porous cylinders are used to line the inner wall of the mixing zone (cool zone) 18 of a reforming reactor, which is described in the following section and schematically illustrated in FIG. 1. Porous walls are preferred in the cool zone of the reformer because of limited oxygen transport through dense materials at low temperatures. In the hotter regions (hot zone 14), which will see temperatures of about 1000° C., the porous wall preferably transitions to denser material that will restrict flow of nitrogen into the reformer.

For surrounding the hot zone 14 of reformer 1, porous yttria-stabilized zirconia cylinders coated with very thin layers (<100 μm) of dense ceramic oxygen transport membrane materials are prepared. The inner reactor wall is created so as to effuse and diffuse oxygen and to be self-cleaning when used in the reactor to make synthesis gas. By providing a source of oxygen, the self-cleaning reactor walls oxidize and prevent the build-up of carbon, which has until now prevented the successful commercialization of liquid fuel reformers. Preferably the portion of the wall that surrounds the reactor hot zone 14 is formed from ceramic powders of yttria-stabilized zirconia and coated with a diesel fuel reforming catalyst and a dense oxygen anion transport material. Ideally, the entire length of the inner wall is fabricated from, or lined with, dense oxygen transport membrane material so as to completely eliminate nitrogen from the reformer. This would allow fuel, especially the more stable polycyclic aromatics, to be more readily oxidized, would eliminate NOₓ, and would allow a more compact design for the fuel reformers and fuel cells. However, because of limited oxygen transport through dense membrane materials in the cooler regions of the reformer (about 300-600° C.) it will usually be necessary to compromise and use more porous wall materials coated with oxidation catalysts in the cooler regions of the reformer.

Coating porous zirconia with dense materials is similar to coating with porous materials except that pore formers are eliminated, particle size is reduced as necessary, and sintering temperature is increased. Because it is not necessary to completely eliminate nitrogen, no great effort to produce completely pin-hole free layers in the dense membrane materials is necessary. An enrichment of oxygen through the dense regions of perovskite is sufficient to greatly improve reformer efficiency and combustion of aromatic compounds.

Although porous material will leak nitrogen, the reformer size, nevertheless, might be reduced by a factor of nearly ten, assuming oxygen flux through the porous materials are approximately ten times that through the dense materials, albeit accompanied with nitrogen. Dense membrane materials are preferred in the hottest regions (hot zone 14) to partially restrict entrance of nitrogen. It is predicted that elimination of only a little over 12% of the nitrogen will enrich the fuel mixture with enough oxygen to provide large benefits in overall system efficiency, and that it is not absolutely necessary to eliminate all nitrogen in a practical diesel fuel reformer. Oxygen anions diffuse readily through select dense ceramic material at 800-1000° C. and can diffuse through silver at much lower temperatures. Dissociated oxygen can diffuse laterally on the surface of some ceramic materials to temperatures as low as 400° C. and on the surface of silver to much lower temperature. This surface diffusion of dissociated oxygen may allow insertion of dense membrane materials in regions of low temperatures, in which dense materials would not traditionally be applied.

According to Ellingham diagrams,⁶ silver should not form bulk sulfides to temperatures as low as 300° C., as long as the H₂:H₂S molecular ratio is above about 10,000:1. Thin films of silver deposited onto porous yttria stabilized zirconia could be an option in temperature regions for which bulk diffusion of oxygen anions is limited in dense ceramic materials. It is repeated here that silver was used with success in solid oxide fuel cell research in the 1960s to suppress deposition of carbon on reformer walls.⁵

Porous yttria-stabilized zirconia tubes are preferred as substrates for various active inner wall materials. The cylinders will extend the entire length of the reformer, from the radiation shield 8 shown in FIG. 1 through the hot zone 14. Yttria-stabilized zirconia is selected because of its well documented stability in solid oxide fuel cell research and for its compatibility with fuel cells downstream. The robust tube of porous yttria-stabilized zirconia acts as a stable substrate for deposition of various self-cleaning inner wall materials, both porous and dense. Inner surfaces of the yttria-stabilized zirconia cylinders are coated with porous perovskite diesel fuel reforming catalysts in the cooler zones and are graded to more dense and refractory perovskite materials towards the hotter zones. The deposition of perovskite-type materials onto yttria-stabilized zirconia is somewhat analogous to the use of perovskite electrode materials on YSZ electrolytes used in solid oxide fuel cell research. The hot zone itself, operating at 1000° C., preferably employs a thin film of dense zirconia material. More active, albeit less thermally stable catalysts, which were identified as described above in foregoing sections, may be used in the coolest zones, which see temperatures in the range of about 400-750° C. This composition then transitions to the more refractory perovskite catalysts in the hotter zones, which typically see temperatures in the range of about 750-900° C. In some instances, it may be advantageous to employ dense silver membranes in the coolest zones. Silver is easily deposited onto zirconia using electroless chemical means. Because some nitrogen is tolerated, it is not necessary to make the silver films absolutely pinhole free.

For example, powders of 8 mole % yttria stabilized zirconia are mixed with a pore-former such as starch, and a binder such as polybutyrate. The mixture is pressed into a cylinder using standard bag-and-mandrill techniques. Green bodies are fired in air, burning out the pore formers and binders and sintering the zirconia particles together, to provide a wall or wall liner having a porosity of about 35-40%, which readily diffuses air. Finished, porous cylinders are preferably tested for stability in thermal cycling. Permeability of the porous cylinder towards air may be measured using a standard bubble-meters to quantify air flow out of the exhaust. Porosity is further optimized, if desired, by varying the quantity of pore-former to maximize porosity and flux, while maintaining mechanically and thermally stable walls.

### XIII. Catalytic Membrane Reactor

Referring again to the conceptual drawing of the embodiment of a catalytic membrane reactor 1 shown in FIG. 1, outer wall 15 defines a tubular or cylindrical vessel having an annular space 13 in which a second vessel comprising a tubular or cylindrical inner wall 2 of the reformer is disposed. Annular space 13 comprises an air inlet 6, an outlet 4 for exhausting N₂-enriched air, and a boundary 7 between the hot zone 14 and an exhaust zone 19. Exhaust zone 19 is in fluid communication with hot zone 14 for receiving produced syngas. A portion 16 of inner wall 2 surrounds a cool zone 18, and comprises porous catalytic material/oxygen transport material that is capable of adsorbing and dissociating molecular oxygen into highly active atomic oxygen, oxygen ions, O₂—, or other active oxygen species, and is capable of providing active oxygen on the inner walls of the cool zone 18 of the diesel fuel reformer 1. As noted above, the term “active oxygen” refers to oxygen species that are active for reacting with a hydrocarbon fuel in the presence of a reforming catalyst. Active oxygen species include, but are not limited to, atomic oxygen, oxygen anions (O²⁻), and molecular oxygen.

Cool zone 18 has a fuel inlet 3 and a radiation shield 8, and is followed by hot zone 14. Reactor hot zone 14 is surrounded by portion 12 of inner wall 2, and contains the reforming catalyst 5. Portion 12 comprises comparatively denser materials than that of portion 16, and serves to restrict flow of nitrogen into the reformer via wall 12 while effusing at least some O₂ into the hot zone. The “self-cleaning” catalytic membrane reactor wall 2 is capable of suppressing, and preferably eliminating, deposition of carbon during operation of the reformer. “Self-cleaning” refers to the ability of the wall material to avoid and/or eliminate deposition of carbon on the reactor walls. The density (i.e., gas permeability) of wall 12 may be uniform over the entire length of the reformer, or, preferably, the portion of the wall adjacent to the reactor hot zone 14 is denser than the portion of the wall adjacent to the mixing or cool zone 18. In the latter case, comparatively less dense oxygen transport membrane material makes up the portion of wall 12 adjacent to the mixing or cool zone 18. The reformer's inner wall is preferably fabricated from refractory oxides that are optimized, as described in the preceding sections, for maximum oxygen transport and maximum diesel fuel reforming activity, while retaining stability and activity at 1000° C. A porous catalytic membrane reactor wall is chosen instead of a dense wall, in the design of the reactor, in order to deliver the relatively large quantities of air required for a 5000 W fuel reformer, for example, while maintaining a compact reformer size. A highly preferred system is compact, inexpensive to make, capable of stable operation, and is capable of using commercial grade diesel as a feedstock and preventing carbon build-up by transport of oxygen through self-cleaning reformer walls. While representative embodiments of the new reformer focus on a single inner wall enclosing a single cool zone and a single hot zone, it should be understood that the reformer could have an outer wall that is other than cylindrical, and could contain multiple inner vessels, each having a cool zone and a catalytic reforming zone (hot zone) for parallel production of synthesis gas.

When the reformer is employed for producing synthesis gas from diesel fuel, high oxygen flux through the membrane to the inner reactor wall reacts with and removes carbon which may temporarily form, as described in more detail elsewhere herein.

The catalytic membrane reactor 1 comprises porous walls 12 composed of pressed, sintered, oxidation catalysts which readily adsorb and dissociate molecular oxygen for transporting air from the air side of the membrane to the fuel side. The porous catalytic membrane reactor walls 12 form essentially a self-cleaning system, effectively suppressing deposition of carbon. In some variations of the assembly, reactor inner walls are fabricated from one or more refractory oxides which are optimized as described elsewhere herein for maximum oxygen transport and maximum diesel fuel reforming activity, while retaining stability and activity at 1000° C. Porous catalytic membrane reactor walls rather than dense walls are chosen in the design of the reactor in order to deliver the relatively large quantities of air required for a 5000 W fuel reformer, while maintaining a compact reformer size. A catalyst bed, optimized for porosity, pore size, catalyst granule or catalyst pellet size or other physical configurations, is positioned in the reactor hot zone. The catalyst bed of the reactor's hot zone 14 may contain the same or a different oxygen conducting oxide than that of the membrane forming, or lining, the inner wall of the reactor. The reforming catalyst may comprise a single chemical compound or it may include two or more different compounds (e.g., two or more perovskites), or it may be in the form of elemental metal or alloy. Some representative examples of combinations of inner wall compositions and reforming catalysts for use in the hot zone of the reactor are as follows:

### Example 1

Porous wall of yttria stabilized zirconia (or other ceramic) is coated with perovskite oxidation catalysts, especially La₁₋ₓCaₓFeO_{3-δ} (or variations of this perovskite material, such as La₁₋ₓSrₓFeO₃₋₆, La₁₋ₓSrₓCoO_{3-δ}, La₁₋ₓCaₓCoO_{3-δ}, La₁₋ₓCaₓMnO₃₋₆, La₁₋ₓSrₓMnO_{3-δ}). La₁₋ₓCaₓFeO₃₋₆ and variations thereof are used as oxidation catalysts in the hot zone (1000° C.) of the reactor.

### Example 2

Porous wall of yttria stabilized zirconia is coated with Pt—Rh oxidation catalyst in the cool zone of the reactor (300-900° C.). Platinum-rhodium catalyst is dispersed within the pores of the ceramic reactor wall using electroless deposition. Wire Pt—Rh gauze is used as the oxidation catalyst in the hot zone of the reactor (>1000° C.).

### Example 3

Porous wall of yttria stabilized zirconia coated with perovskite oxidation catalyst such as La₁₋ₓCaₓFeO_{3-δ} and allied materials, is employed along with Pt—Rh gauze in the hot zone of the reactor.

### Example 4

Porous wall of the reactor is composed of La₁₋ₓCaₓFeO_{3-δ} and allied perovskite materials without use of yttria stabilized zirconia. Catalyst in the hot zone comprises La₁₋ₓCaₓFeO_{3-δ} and allied perovskite materials, or Pt—Rh wire gauze.

### Example 5

Porous wall of the reactor is composed of oxygen-conducting cerates.

### Example 6

The wire gauze of Pt—Rh in the reactor hot zone is replaced with wire gauze of Pt, Rh, Ir, W, Mo, Co, and Fe and alloys thereof.

### Example 7

Porous metal foam or one or more porous metals selected from Pt, Rh, Ir, W, Mo, Co and Fe, and alloys thereof, or one or more of those metals or alloys coated onto porous ceramic foam or porous ceramic replace the Pt—Rh wire gauze in the reactor hot-zone.

### Example 8

Various oxidation catalysts such as hexaaluminates, cerates, perovskites and other oxygen conducting oxides are used as oxidation catalysts in the porous walls or in the hot zone, provided that they are catalytic for reforming hydrocarbons to syngas and are active for the dissociation of molecular oxygen and for transporting atomic oxygen.

A. Calculations of Fuel and Oxygen Consumption for a 5 kW Reformer.

A quantitative analysis was made of the technical requirements for any diesel fuel reformer capable of delivering sufficient fuel to power a 5 kW fuel cell. These data are summarized in Table 5 and are applicable to any fuel reformer development, and not only the reformers disclosed herein. Calculations were performed for the desired consumption of liquid diesel fuel and for consumption of oxygen in the fuel reformer. In order to obtain a conservative maximum size estimate for a reformer system, the calculations used an overall system efficiency of 40%, which is believed to be about the lowest that is currently feasible for small state of the art systems. This then sets the limits for the largest reformer that is practical.

TABLE 5
Flow Requirements for a 5 kW Fuel Reformer (Various Units)

| Diesel Fuel | | Oxygen | | Air | | Hydrogen | | CO | |
|---|---|---|---|---|---|---|---|---|---|
| 0.292 | g s⁻¹ | 0.635 | mol O₂ min⁻¹ | 67.8 | L min⁻¹ | 2.26 | mol H min⁻¹ | 1.27 | mol min⁻¹ |
| 0.344 | mL s⁻¹ | 14.2 | L min⁻¹ | 2.39 | ft3 min⁻¹ | 2.24 | g min⁻¹ | 35.6 | g min⁻¹ |
| 17.5 | g min⁻¹ | 0.500 | ft3 min⁻¹ | 1130 | mL s⁻¹ | 50.7 | L min⁻¹ | 28.5 | L min⁻¹ |
| 1.05 | kg hr⁻¹ | 237 | mL s⁻¹ | 143 | ft3 hr⁻¹ | 844 | mL s⁻¹ | 475 | mL s⁻¹ |
| 20.6 | mL min⁻¹ | 20.3 | g min⁻¹ | 4070 | L hr⁻¹ | 1.79 | ft3 min⁻¹ | 1.00 | ft3 min⁻¹ |

| | | | | | | | | |
|---|---|---|---|---|---|---|---|---|
| 1.24 | L hr⁻¹ | 1220 | g hr⁻¹ | — | 134 | g hr⁻¹ | 2140 | g hr⁻¹ |
| 0.328 | gallons hr⁻¹ | 2.68 | lbs hr⁻¹ | — | 0.296 | lb hr⁻¹ | 0.973 | lb hr⁻¹ |

Details of the calculations are as follows: To provide 5 kW of electrical power at 40% overall efficiency, the total chemical energy contained in the liquid diesel fuel must enter the system at a rate of:

(5 kW)(100/40)=12.5 kW(i.e., 40% of 12.5 kW=5 kW) (10)

This will be true of any system which can be devised having an overall efficiency of 40%.

If 42.8 MJ kg⁻¹ is used as a representative value of chemical energy which can be derived from the complete oxidation of one kilogram of liquid diesel fuel, then a 5 kW fuel cell system with its associated fuel reformer operating at 40 percent overall efficiency, will consume:

(5 kW)(100/40)(1000 W/kW)(1 Js⁻¹/W)(kg/42.8 MJ)(1000 g/kg)(MJ/10⁶ J)=0.292 g s⁻¹ (11)

The corresponding flow in terms of volume, using a measured density of liquid diesel fuel of 0.850 g mL⁻¹ (at 25° C.), is: (0.292 g s⁻¹)(mL/0.850 g)=0.344 mL s⁻¹ (at 25° C.). In alternative units, the required feed of liquid diesel fuel is: 17.5 g min⁻¹ (1.05 kg hr⁻¹) or 20.6 mL min⁻¹ (1.24 L hr⁻¹ or 0.328 gallons hr⁻¹).

Next, the quantity of oxygen required by the diesel fuel reformer is calculated. For estimates of oxygen consumption, it is first necessary to determine the number of moles of both carbon and hydrogen in a unit mass of commercial diesel fuel and their rate of consumption in the fuel reformer. Analysis of diesel fuel (Conoco Phillips D-2), was performed for Eltron Research Inc. by a certified analytical laboratory (Galbraith Laboratories, Inc. of Knoxville, Tenn.). The analysis yielded a composition of 87.00 mass percent carbon and 13.00 mass percent hydrogen. From these measured values, and using atomic weights of 12.011 and 1.00794 for C and H, respectively, the moles of carbon and hydrogen per gram of diesel fuel are calculated:

(0.8700 g C/g fuel)(mol C/12.011 g C)=0.07243 mol C/g fuel (12)

(0.1300 g H/g fuel)(mol H/1.00794 g H)=0.1290 mol H/g fuel. (13)

The atomic ratio in the diesel fuel of hydrogen to carbon, H/C, an important value which is required in later stoichiometric and thermodynamic calculations, is thus:

(0.129 mol H/0.0724 mol C)=1.781 mol H to 1 mol C

From this, the “average” molecular formula of hydrocarbons in the diesel fuel can be symbolized as C₁H_{1.781}. The atomic ratio of hydrogen to carbon in the fuel is critical for calculations estimating the minimum required reforming temperature which can be achieved without danger of deposition of carbon, which can plug reactors. (Note: This batch of fuel differed slightly from the earlier batch, containing C₁H_{1.86}, but does not greatly affect estimates.) Consumption rate of moles of carbon and moles of hydrogen by a 5 kW fuel cell/fuel reformer system with 40% overall efficiency is calculated as follows:

(0.292 g fuel s⁻¹)(0.07243 mol C/g fuel)=0.0211 mol C s⁻¹ or 1.27 mol C min⁻¹ (14)

(0.292 g fuel s⁻¹)(0.1290 mol H/g fuel)=0.0377 mol H s⁻¹ or 2.26 mol H min⁻¹ (15)

In order to calculate the minimum flow rate at which oxygen must be fed into the fuel reformer, the number of moles of oxygen required must first be calculated. From the atomic ratio of H/C of 1.781/1 calculated above, and the average molecular formula in the diesel fuel symbolized as: C₁H_{1.781}, the ideal partial oxidation reaction of diesel fuel is symbolized as:

C₁H_{1.781}+½O₂=CO+(½)(1.781)H₂+Heat (16)

Equation 16 takes into account the two atoms of oxygen in molecular oxygen and assumes that the ideal partial oxidation reaction requires one oxygen atom for each carbon atom in the fuel to form one molecule of CO.

From Equation 14, 1.27 mol C min⁻¹ must be consumed in the fuel reformer, and, therefore, from Equation 16, 1.27 mol O min⁻¹ must also be consumed because the atomic ratio of oxygen:carbon in CO is 1:1. For molecular oxygen, O₂, the rate of consumption is:

(1.27 mol O min⁻¹)/(2 mol O min⁻¹/1 mol O₂ min⁻¹)=0.635 mol O₂ min⁻¹ (17)

Assuming ideal gas behavior in which 1 mole of any gas occupies 22.414 L at standard temperature (25° C.) and pressure (1 atm), the STP flow rate of molecular oxygen required by the fuel reformer is:

(0.635 mol O₂ min⁻¹)(22.414 L O₂/mol O₂)=14.2 L O₂ min⁻¹(STP) (18)

This is the minimum flow rate of oxygen required in a fuel reformer designed for a 5 kW fuel cell, assuming ideal reforming conditions, 40% overall system efficiency and ideal stoichiometry for partial oxidation (i.e., one mole of O for one mole of C to form one mole of CO). In practice, oxygen in very slight excess of ideal stoichiometric quantities will be required to completely suppress deposition of carbon.

Next the flow rate of air which is required to provide the necessary oxygen to the fuel reformer is calculated. If oxygen is diluted by the nitrogen, argon and other components of air, and if dry air is assumed to contain 20.946 volume percent oxygen, and if 100% of the oxygen can be extracted from the air, then the minimum flow rate of dry air which will be required by the fuel reformer is:

(14.2 L O₂ min⁻¹)(100/20.946)=67.8 L air min⁻¹(STP) (19)

In alternative units, the flow rate of dry air must be: 2.39 ft³ air min⁻¹. If the air is humid, containing up to 4% by volume water vapor, the flow of air required would rise up to just over 70 L air min⁻¹ (STP).

Before a design of a fuel reformer can be envisioned, it is next necessary to calculate the energy required to heat the above quantity of air to the desired reforming temperature. If it is assumed that the maximum reforming temperature will be 1000° C., then the power required to warm 67.8 L air min⁻¹ of dry air from 0° C. to 1000° C. (273° K. to 1273° K.) is estimated by:

(31.3 J mol⁻¹K⁻¹)(1000 K)(67.8 L min⁻¹)(mol/22.414 L)(W/Js⁻¹)(min/60 s)=1,580 W=1.58 kW, (20)

assuming, for simplicity, an average heat capacity at constant pressure, Cₚ, of air of 31.3 J mol⁻¹K⁻¹.

This is the minimum rate for which heat must be added to heat the air to a reforming temperature of 1000° C. This assumes adiabatic operation of the fuel reformer and no thermal losses through the walls of the reformer. If thermal losses occur, additional heat would be required. It might be noted that the power needed to heat the air to the reforming temperature will consume (1.58 kW/12.5 kW)×100%=15.8% of the chemical energy provided by the diesel fuel.

Next, it is necessary to estimate the energy required to heat the diesel fuel and all of its decomposition products to the reforming temperature. As a first approximation, it is assumed that the heat capacity of the 400 types of organic molecule in the fuel and that of the various decomposition products will be approximately equivalent to that of the H₂+CO, which is ultimately produced. This is, in part, justified theoretically, because the degrees of freedom of translational, rotational and vibrational motion of all molecules present will eventually be transformed to those of H₂+CO. This simplifying assumption being made, one mole of hydrogen and two moles of CO will be produced for each mole of O₂ consumed and for four moles of nitrogen heated to the reforming temperature. All molecules (N₂, O₂, CO, H₂) are diatomic and will theoretically, to the first approximation, have the same heat capacity at constant pressure, C_{P}. Thus, a crude estimate of the power needed to raise the temperature of the fuel is ⅗ that of heating the air or (⅗)(1.58 kW)=0.948 kW. The total power required to heat both the air and fuel to a reforming temperature of 1000° C. is thus estimated to be: 1.58 kW+0.948 kW=2.53 kW. Although these calculations could be further refined and other assumptions made, they give a starting point for estimating the parasitic power requirements for heating air and fuel in diesel fuel reformers.

Next it is necessary to determine whether or not the energy required to heat both the air and the fuel to the reforming temperature can be provided by the heat released by the partial oxidation of the diesel fuel into H₂+CO or if efficiency must be lost by consuming part of the fuel part to provide the needed heat. The maximum possible heat released by the partial oxidation of diesel fuel to H₂+CO first needs to be calculated. This is estimated using Hess's Law by subtracting the known heat of combustion of H₂+CO from the known energy content of the fuel as follows. Energy released by complete oxidation of the diesel fuel to H₂O+CO₂ is assumed to be 42.8 MJ kg⁻¹. From earlier calculations, total rate of chemical energy entering the reformer, in units of Watts, must be 12.5 kW. Heats of combustion at standard conditions for H₂ and CO are −282.984 kJ mol⁻¹ and −241.818 kJ mol⁻¹, respectively. From Equations 14 and 16, consumption of carbon is estimated to be 1.27 mol C min⁻¹, which will produce CO at a rate of 1.27 mol CO min⁻¹. Complete combustion of this CO to CO₂ would produce heat at a rate of: (1.27 mol C min⁻¹)(241.818 kJ/mol C)=307 kJ min⁻¹ or 5.1 kW. Production of hydrogen will be 2.26 mol H min⁻¹ or 1.13 mol H₂ min⁻¹. Combustion of this H₂ into steam will yield (1.13 mol H₂ min⁻¹)(282.984 kJ/mol H₂)=320 kJ min⁻¹ or 5.3 kW. The total available chemical energy exiting the reformer and entering the fuel cell is thus:

307 kJ min⁻¹+320 kJ min⁻¹⁼⁶²³ kJ min⁻¹ (21)

In units of Watts, this is:

(623 kJ min⁻¹)(W/Js⁻¹)(min/60 s)(kW/1000 W)(1000 J/kJ)=10.4 kW (22)

This simple calculation does not take into account the difference in heats of reaction at standard conditions and at 1000° C.

Subtracting this 10.4 kW produced by combustion of H₂+CO into H₂O+CO₂ from the total of 12.5 kW initially entering the reformer, calculated in Equation 14, yields 12.5 kW−10.4 kW=2.1 kW, which is the rate of energy released by the ideal partial oxidation of diesel fuel to H₂+CO. It should be appreciated that the partial oxidation of the fuel in the fuel reformer will consume approximately: (2.1 kW/12.5 kW)×100%=16.8% of the chemical energy provided by the diesel fuel, which cannot be utilized as chemical energy by the fuel cell.

From the earlier estimate of 2.53 kW required to heat both the air and the fuel to the reforming temperature, it is seen that there could be an energy deficit of 2.53 kW−2.1 kW=0.4 kW=400 W even if the system is perfectly adiabatic and suffers no heat loss through its insulation—and if partial oxidation is ideal and complete (with no escape of un-oxidized fuel). However, considering the simple assumptions made, this is very close to break-even, i.e., the energy released by partial oxidation is just sufficient to heat the air and fuel to 1000° C.

One might use many other assumptions to greatly refine the above calculations. However, whatever other assumptions might be made, it appears clear that all of the heat released by partial oxidation of the diesel fuel in the fuel reformer will need to be efficiently utilized in heating the air and the fuel to the reforming temperature in order not to drop overall efficiencies. On the other hand, the heat released by partial oxidation of the diesel fuel will be very close to exactly that which is required to heat both the air and the fuel to the reforming temperature, so that a break-even condition, in which no external heating is required, appears to be very feasible. Adiabatic operation of the fuel reformer, requiring outstanding insulation or very rapid heat transfer between combustion products and the unheated air and fuel are, therefore, included among the design goals of the diesel fuel reformer.

It should be appreciated that ⅘ of the energy required to heat the air to the reforming temperature and to the fuel cell operating temperature is wasted by heating nitrogen, which is not required for the desired oxidation reactions. Heating nitrogen places a considerable drain on overall system efficiency.

In addition, nitrogen is also undesired in the fuel reformer and fuel cell stack system because of the formation of nitrogen oxides (NOₓ). In addition, the nitrogen adds to the size of the fuel cell stack. If nitrogen from air could be eliminated by separating oxygen from air through an oxygen transport membrane, additional system efficiency could be obtained. Up to ⅘ of 1.58 kW=1.26 kW could be saved by eliminating the heat required to heat the nitrogen from ambient temperature to the reforming temperature. Power needed to heat molecular oxygen alone is approximately (⅕)(1.58 kW)=0.32 kW. If nitrogen could be completely eliminated from the air feed, this could yield up to 2.1 kW−1.26 kW=0.8 kW to spare for heat loss from the system.

It is clear from these preliminary estimates that heating nitrogen to the reforming temperature is a major drain on overall system efficiency. If nitrogen is eliminated, or if at least part of the nitrogen is blocked from entering the system, then overall system efficiency may improve or at least the break-even point could be achieved more readily in which heat produced by partial oxidation of the diesel fuel is more than adequate to heat the fuel, oxygen and residual nitrogen to the reforming temperature without additional expenditure of fuel.

Unique features of the new reformers include use of low-cost catalysts. These new sulfur-tolerant catalysts use inexpensive ceramic oxides and can replace very expensive wire gauze catalysts based upon platinum and rhodium. In addition, the inner walls of the new reformers are designed to effuse and diffuse oxygen, which will suppress formation of carbon on the reformer walls. Until the present time, carbon formation on reactor walls has been a major issue preventing commercial use of fuel reformers. Self-cleaning reactor walls are expected to provide the technologic breakthrough which has been sought for such fuel reformers.

B. Optimization of Reformer Wall and Catalyst Bed Geometry

Ideally, a diesel fuel or JP-8 fuel reformer design might incorporate a platinum-rhodium or platinum-iridium wire gauze in the center of the reformer hot zone instead of a lower cost perovskite catalyst, as described herein. In that case, molecular oxygen would adsorb and dissociate on the metal wire surface forming very active and mobile adsorbed atomic oxygen on the wire surface which would readily react with most varieties of hydrocarbon molecules. Heat rapidly released at the wire surface by oxidation of fuel would maintain the wire gauze at 1000-1500° C., which would be more than adequate to suppress deposition of carbon or formation of noble-metal sulfides. Heat exchange between cool fuel and cool air and the hot wire gauze would be rapid. Although heat losses due to emission of electromagnetic radiation and conduction out past the small rim of the gauze into the reactor walls would occur, a wire gauze catalyst system, nevertheless, would be close to ideal as far as heat transfer and heat loss through wall insulation are concerned. In addition, catalyst wires can be heated electrically to initially ignite the fuel/air mixture. The major drawback of the noble metal gauze system is the high cost of Pd—Rh and Pt—Ir gauze, which is typically more than $300 for a single 50×50 mm screen, at the present time. Multiple wire gauze screens would probably be required for full conversion of the fuel. This cost is not practical for fuel reformers that are to be used in commercial diesel trucks, which must compete with diesel engine generators costing as little as $700.

In this disclosure is demonstrated that perovskite-based oxidation catalysts or perovskites supported on yttria-stabilized zirconia can potentially take the place of the expensive noble-metal gauzes. It is possible to further optimize the catalyst bed geometry. For instance, the optimum catalyst configuration may be in the form of a thin, porous, pressed disk spanning the reactor, with parallel flat disk surfaces placed perpendicular to the flow of fuel. Alternatively, an optimum catalyst configuration might be an extruded channeled catalyst monolith, a simple packed bed of catalyst granules or a bed of pressed catalyst pellets. It is expected that the system can also be improved by including a system for initially igniting the fuel/air mixture using an electrically heated wire, spark plug, or ceramic glow-bar.

### XIV. Process for Producing Synthesis Gas

A catalytic membrane reformer as shown schematically in FIG. 2 is employed for converting high-sulfur fuels, especially commercial diesel fuel, but also the military JP-8 fuel and bottom-of-the barrel petroleum reserves into a mixture of synthesis gas (H₂+CO). The compact system can be fed all grades of sulfur-containing diesel as well as other liquid and gaseous fuels ranging from natural gas to bottom-of-the-barrel petroleum residue. For example, a diesel fuel feedstock may contain as much as 200 ppm sulfur (by mass). Air flows into the annular space 13 between the outer wall 15 and inner wall 12 of the reactor. The portion of cylindrical inner wall 12 that surrounds cool zone 18 comprises porous catalytic materials that are capable of adsorbing and dissociating molecular oxygen into highly active atomic oxygen and for transporting atomic oxygen into the cool zone 18 of the diesel fuel reformer 1. High oxygen flux through the membrane to the inner reactor wall reacts with and removes any carbon which may temporarily form. The deposition of carbon on the reactor walls is suppressed by maintaining very high local concentrations of oxygen at the surface of wall 12, thus making formation of elemental carbon thermodynamically unstable and rendering the inner wall of the reactor “self-cleaning.” In the cool zone 18, a stream of fuel vapor mixes with O₂ and N₂, which then flow into the hot zone 14.

The portion of inner wall 12 that surrounds the hot zone 14, and comprises comparatively denser materials, restricts flow of nitrogen into the reformer via wall 12, and provides an oxygen enriched atmosphere near the catalyst bed (in hot zone 14) that oxidizes polycyclic aromatic compounds in the diesel fuel. Selective diffusion of oxygen through dense membrane layers restricts entry of nitrogen, allowing increased overall system efficiency. The overall concentration of oxygen in the reactor system is preferably close to the 1:1 ratio of carbon to oxygen required by thermodynamics and for high overall system efficiency. The oxidation catalyst in the hot zone of the tubular reactor, operating at 1000° C. or above, transforms liquid hydrocarbon fuels into predominantly H₂+CO, without appreciable formation of carbon. The denser, less porous nature of the inner wall surrounding the hot zone 14 also blocks egress of syngas through the inner wall. Accordingly, the stream of produced synthesis gas exits the catalyst bed into the exhaust zone 19, where it can be harvested for downstream applications. For example, the produced synthesis gas is useful as a fuel for solid oxide fuel cells and automotive turbine engines, and it may also be used to form various alternative fuels including synthetic diesel fuel, synthetic natural gas, methanol and hydrogen.

With respect to the transition in the composition of wall 12, or the cylindrical lining of wall 12, more porous wall materials, rather than dense oxygen transport materials, are preferably employed for the cool zone of the reformer because of limited oxygen transport in most dense materials at lower temperatures and the need to produce compact fuel reformers for automotive use. The more active perovskite-based catalysts (identified in preceding sections) are adequate for use in the cool zone of the catalytic membrane reactor. A catalyst formulation prepared from La₁₋ₓSrₓFeO_{3-δ}/YSZ is preferred for use in the hot zone. In tests described in the preceding sections, a representative catalyst was catalytically stable over a two-month test in continuous operation at 1000° C. No formation of sulfides, carbonates or sub-oxides was detected by x-ray powder diffraction. The zirconia retained its original crystal structure. Few catalyst systems can operate under these extreme operating conditions, and these catalysts are expected to find many applications for which high-temperature oxidation is required.

Embodiments of the new reforming reactor include a membrane which brings oxygen through the walls of a reactor, keeping the local concentration of oxygen near the inner walls very high so as to suppress deposition of carbon. Various catalysts may be deposited on the inner walls to aid oxidation of carbon, but all sections of the walls need not contain a catalyst if oxygen is present in high concentration. Most of the fuel reforming occurs in a bed of catalyst or wire gauze or other catalyst configuration in the hot zone of the reactor. Perovkites are highly effective in reforming fuel in the hot zone, and in many applications can replace more expensive materials based upon platinum-rhodium wire gauze or platinum-rhodium dispersed on supports.

Embodiments of the above-described process potentially provide a better way to de-sulfurize high-sulfur feedstocks. Catalytic gasification of sulfur-containing compounds to synthesis gas also will produce H₂S under these highly reducing conditions. The H₂S can be removed by well-established industrial means. After the sulfur is removed, the synthesis gas can then be used to produce Fischer-Tropsch liquids, methanol, synthetic natural gas, and the like. A great advantage of the syngas route for removing sulfur, is that it does not require large quantities of hydrogen as with hydrodesulfurization. Routes which reduce or circumvent use of hydrogen will be in great demand in the near future as more marginal (high-sulfur) reserves of petroleum must be utilized. For example, much petroleum in California and Texas goes unutilized because of high sulfur content. Removal of this sulfur would be of great benefit to theses states and the nation.

Oxidation of sulfur in engines can lead to production of sulfuric acid, H₂SO₄, a major constituent of acid rain. The sulfuric acid in acid rain, also produced by burning high-sulfur coal, is responsible, in part, for destruction of forests world-wide. The non-volatile nature of sulfuric acid, which limits evaporation and allows it to remain on plant tissues, is especially destructive to plants. Sulfuric acid in acid rain, produced from high-sulfur fuels, is much more of a concern than acid rain produced by oxides of nitrogen (NOₓ), which are quite volatile.

High levels of sulfur in liquid fuels have been shunned since at least the 1920s in civilian craft, not because of concerns over air pollution, but rather because of very severe corrosion of engine parts and exhaust systems caused by sulfuric acid. For commercial use, fear of engine corrosion has always been a large factor in disuse of high-sulfur diesel fuel.

Reformers capable of processing, so-called, bottom-of-the barrel, high-sulfur petroleum feedstocks to produce very low-sulfur synthetic diesel fuel will be in very high demand in the very near future. New legislation has been passed in many states to reduce sulfur in diesel fuel to 50 ppm (by mass), which will require use of synthetic diesel fuel. Synthetic diesel fuel is produced from synthesis gas (H₂+CO) by Fischer-Tropsch methods, which produce fuels which are extremely low in sulfur. As the United States is forced to use more marginal supplies of petroleum, issues related to sulfur contamination in so-called bottom-of-the-barrel petroleum feedstocks will become more critical. Currently, high-sulfur fuels are largely restricted to military use in fuels such as JP-8 (Jet-Propulsion Fuel #8) which may contain 3,000-10,000 ppm (by mass) sulfur. In comparison, many states now would like to restrict levels of sulfur in diesel fuel to 15 ppm (by mass) from previous allowed levels of 200 ppm (by mass).

Processed bottom-of-the-barrel petroleum feedstocks may also be very high in polycyclic aromatic compounds. Many polycyclic aromatic compounds are among the most potent human carcinogens known. Use of bottom-of-the-barrel petroleum products in diesel engine vehicles could lead to increased rates of cancer in the United States. Unlike fuels refined from petroleum, synthetic diesel fuels produced by Fisher-Tropsch methods are composed almost exclusively of straight-chain alkanes and alcohols, which will largely eliminate the cancer risk. Moreover, the oxygen provided by the alcohols in Fischer-Tropsch liquids will allow diesel fuel to burn more completely, greatly reducing soot emitted from diesel engines. Soot from diesel exhaust, which is known to adsorb and transport carcinogenic polycyclic aromatic compounds, is another well established risk to human health. Synthetic diesel fuel produced from bottom-of-the-barrel petroleum feedstock will require production of synthesis gas from fuel reformers. Reformers, tolerant to sulfur, and capable of reforming bottom-of-the-barrel petroleum reserves into safer, low-polluting synthetic diesel fuels will be in high demand.

In addition to using fuel reformers to produce synthesis gas for production of synthetic diesel fuel, the synthesis gas can be used to produce methanol, CH₃OH, another candidate as an alternative fuel. Hydrogen and CO in synthesis gas can also react to produce methane, CH₄, the major constituent in natural gas (3H₂+CO=CH₄+H₂O). Fuel reformers and synthesis gas could provide means for augmenting dwindling supplies of natural gas from bottom-of-the-barrel petroleum reserves.

Synthesis gas produced by fuel reformers can be passed through water-gas shift reactors which react CO and steam to produce hydrogen: CO+H₂O=H₂+CO₂. Hydrogen can be used as a non-polluting fuel in fuel cells or can be used in chemical synthesis.

The synthesis gas mixture of H₂+CO produced by fuel reformers can be used as a fuel in solid oxide fuel cells. Solid oxide fuel cells may find application in large, more efficient, electric power plants and in various other electric devices. The U.S. military has long sought sulfur tolerant JP-8 fuel reformers which could provide H₂+CO fuel for solid oxide fuel cells. Liquid fuels such as JP-8, with their very high chemical energy content, could provide reliable sources of electric power at a fraction of the weight and cost of present batteries if JP-8 could be efficiently reformed and the H₂+CO fed to power solid oxide fuel cells.

Synthesis gas, produced by fuel reformers, can also be used to run turbine engines of various size. As supplies of natural gas dwindle, large electric power plants, which now employ very large turbine engines run on natural gas, are actively seeking sources of synthesis gas derived from either coal or bottom-of-the barrel petroleum reserves. Turbine engines have long been used in jet aircraft and in ships. A recent trend has been to employ smaller turbine engines in automobiles and trucks. Turbines used in vehicles relying on diesel fuel, require fuel reformers to convert diesel fuel into mixtures of H₂+CO, which can then be used to power the smaller automotive turbine engines. The demand for small automotive fuel reformers used with turbine engines may initially drive mass production of diesel fuel reformers, which when widely available at low cost, could be adapted as reformers for solid oxide fuel cells.

In summary, because synthesis gas, H₂+CO, will have increasing widespread use in the economy, ranging from production of synthetic fuels, production of clean hydrogen, and operation of efficient fuel cells and turbine engines, fuel reformers, capable of producing synthesis gas from high-sulfur liquid feedstocks will also have wide spread use, creating new jobs and opportunities in the petroleum industry, chemical industry, automotive and manufacturing industry. In addition, the widespread use of fuel reformers can potentially have a positive impact on public health and the environment by largely eliminating sulfur and carcinogenic aromatic compounds from automotive fuels. Some of the potential beneficiaries of the new technology are workers in fuel cell research and development in need of fuel reformers for diesel and JP-8; electric power utilities adopting fuel cells; automobile, truck, and off-road vehicle manufacturers and their suppliers in need of more efficient electric power for vehicles; automobile, truck, and off-road vehicle manufacturers and their suppliers, producing small turbine engines in need of syngas for turbine fuel; the U.S. Military services seeking more efficient use of JP-8 for generation of electricity in fuel cells; petroleum producers seeking utilization of high-sulfur petroleum reserves in California, Texas, Oklahoma, Pennsylvania, Ohio, Wyoming, Colorado and elsewhere; petroleum refiners, nationwide, seeking efficient methods for utilization of bottom-of-the barrel petroleum supplies; natural gas producers, with high-sulfur gas wells and un-utilized natural gas; manufacturers of ceramic tubes and ceramic catalyst pellets; and the general public because of reduced cancer risk caused by carcinogens in present fuels and reduced respiratory risk due to decreased sulfur in synthetic fuels produced from syngas.

### REFERENCES

1. G. A. Olah and Á. Molnár, “Hydrocarbon Chemistry,” (Wiley, New York, 1995).
2. J. W. Wigger and B. E. Torkelson, Petroleum Hydrocarbon Fingerprinting-Numerical Interpretation Developments,” http://www.elmengineering.com/Hydrocarbon%20Fingerprinting.htm.
3. T. W. Graham Solomons, “Organic Chemistry, Sixth Edition,” (Wiley, New York, 1996).
4. A. V. Kiselev and V. I. Lygin, “Infrared Spectra of Surface Compounds,” (Wiley, New York, 1975).
5. J. G. Smith, “Hydrocarbon Fuels,” in: “An Introduction to Fuel Cells,” Edited by K. R. Williams, (Elsevier, Amsterdam, 1966) Chapter 9.
6. L. S. Darken and R. W. Gurry, “Physical Chemistry of Metals,” (McGraw-Hill, New York, 1953) p. 361.
7. F. Jones, “Fuel Cells with Molten Carbonate Electrolytes,” in: “An Introduction to Fuel Cells,” Edited by K. R. Williams, (Elsevier, Amsterdam, 1966) Chapter 7.
8. R. J. H. Voorhoeve, J. P. Remeika, and L. E. Trimble, “Nitric Oxide and Perovskite-Type Catalysts: Solid State and Catalytic Chemistry,” in: “The Catalytic Chemistry of Nitrogen Oxides,” Edited by R. L. Klimisch and J. G. Larson, (Plenum, New York, 1975) pp. 215-233.
9. F. S. Galasso, “Structure, Properties and Preparation of Perovskite-Type Compounds,” (Pergamon, Oxford, 1969).
10. G. Saracco, V. Serra, V. Specchia, A. Delmastro, M. Vallino and F. Abbattista, “Simultaneous Abatement of Diesel Soot and NOₓ by Perovskite-Type Catalysts, in: Catalyst Materials for High-Temperature Processes,” Edited by K. S. Ramesh, M. Misono and P. I. Gai, (American Ceramic Society, Westerville, Ohio, 1997) pp. 27-38.
11. V. Specchia, and G. Saracco, “Membrane Catalysis-State of the Art,” in: Catalyst Materials for High-Temperature Processes,” Edited by K. S. Ramesh, M. Misono and P. I. Gai, (American Ceramic Society, Westerville, Ohio, 1997) pp. 147-168.
12. M. Misono and N. Mizuno, Design of Catalysts Based on Perovskite-Type Catalysts,” in: Catalyst Materials for High-Temperature Processes,” Edited by K. S. Ramesh, M. Misono and P. I. Gai, (American Ceramic Society, Westerville, Ohio, 1997) pp. 67-84.
13. Di-Jia Liu and M. Krumpelt, “Activity and Structure of Perovskites as Diesel-Reforming Catalysts for Solid Oxide Fuel Cells,” Int. J. Ceram. Technol. 2[4] (2005) 301-307.
14. M. Krumpelt, S. Ahmed, R. Kumar and R. Doshi, “Partial Oxidation Catalysts,” U.S. Pat. No. 6,110,861, Aug. 29, 2000.
15. H. J. Rösler, “Lehrbuch der Minerologie,” (VEB Deutscher Verlag für Grundstoffindustrie, Leipzig, 1988) p. 391.
16. V. E. Henrich and P. A. Cox, “The Surface Science of Metal Oxides,” (Cambridge University Press, Cambridge, 1996) pp. 36-42.
17. J. B. Goodenough, “Localized to Itinerant Electronic Transition in Perovskite Oxides, (Springer, Berlin, 2001).
18. N. Tsuda, K. Nasu, A. Fujimori, and K Siratori, “Electronic Conduction in Oxides,” (Springer, Berlin, 2000).
19. S. Lowell and J. E. Shields, “Powder Surface Area and Porosity, (Chapman and Hall, London, 1991).
20. S. Dutta and H. A. Wright, “Synthesis Gas Processing Comprising Partial Oxidation Using Controlled and Optimized Temperature Profile,” U.S. Patent Application Publication No. 2006/0029539 A1, published Feb. 9, 2006.

While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims. The disclosures of all patents, patent applications, and publications cited herein are hereby incorporated herein by reference in their entirety, to the extent that they provide exemplary, procedural, or other details supplementary to those set forth herein.

What is claimed is:

1. A catalytic reformer for producing synthesis gas from a hydrocarbon fuel, comprising:
(a) a first vessel comprising an air inlet, a reactor outer wall, an annular space and an air exhaust outlet; and
(b) a second vessel located in said annular space and including:
(i) a cool zone comprising a fuel inlet,
(ii) a hot zone in fluid communication with said cool zone and comprising a synthesis gas outlet and a reforming catalyst, and
(iii) a reactor inner wall surrounding said cool and hot zones and including a membrane comprising at least one metal oxide that transfers oxygen from said annular space through said inner wall and effuses active oxygen into at least one of said cool zone and said hot zone when the reformer is operated to produce synthesis gas.

2. The reformer of claim 1, wherein said first vessel further comprises an exhaust zone configured for receiving reacted gases from said hot zone.

3. The reformer of claim 1, wherein said membrane, or a section thereof, further comprises a carbon suppression catalyst that converts carbon to one or more carbon oxides to suppress carbon deposition on said inner wall when the reformer is operated to produce synthesis gas.

4. The reformer of claim 1, wherein said reforming catalyst in said hot zone comprises:
at least one metal selected from the group consisting of Pt, Rh, Ir, W, Mo, Co, Fe, and alloys thereof, or
a metal oxide selected from the group consisting of hexaaluminates, cerates and perovskites.

5. The reformer of claim 1 wherein said reforming catalyst in said hot zone comprises a metal oxide, and said membrane, or a section thereof, comprises a metal oxide that is the same or different than said reforming catalyst.

6. The reformer of claim 5 wherein at least one of said reforming catalyst and said membrane comprise:
(i) at least one metal oxide having the formula:
La₁₋ₓAₓBO_{3-δ}, wherein A=Ca²⁺ or Sr²⁺, B=Co, Mn, or Fe, wherein x is greater than 0 and less than 1, and δ is the number of oxygen vacancies in the resulting oxide crystal lattice, and
(ii) optionally, a refractory support.

7. The reformer of claim 6, wherein at least one said metal oxide has the formula La₁₋ₓSrₓFeO_{3-δ}, said metal oxide being disposed on a refractory support.

8. The reformer of claim 6, wherein the membrane, or a section thereof, comprises La₁₋ₓCaₓFeO_{3-δ}, optionally deposited on a ceramic support, and the reforming catalyst comprises La₁₋ₓCaₓFeO_{3-δ} or Pt—Rh wire gauze.

9. The reformer of claim 6, wherein said refractory support comprises yttria stabilized zirconia.

10. A reforming process for production of synthesis gas, comprising:
(a) providing a catalytic fuel reformer comprising
(i) a first vessel comprising an air inlet, a reactor outer wall, an annular space and an air exhaust outlet; and
(ii) a second vessel located in said annular space and including:
(1) a cool zone comprising a fuel inlet,
(2) a hot zone in fluid communication with said cool zone and comprising a reforming catalyst and a synthesis gas outlet, and
(iii) a reactor inner wall surrounding said cool and hot zones and comprising a membrane containing at least one metal oxide that transfers oxygen from said annular space through said inner wall and effuses active oxygen into said cool zone and said hot zone;
(b) heating the cool zone to a temperature in the range of about 300-900° C.;
(c) heating the hot zone to a temperature above about 900° C.;
(d) passing an oxygen-containing gas into said air inlet, whereby active oxygen effuses from said membrane into said cool zone and said hot zone; and
(e) passing a hydrocarbon fuel into said fuel inlet, through said cool zone into said hot zone, whereby said hydrocarbon fuel, in contact with said reforming catalyst, reacts with said active oxygen to form synthesis gas.

11. The process of claim 10, wherein (d) comprises effusing sufficient active oxygen from said membrane to said inner wall to maintain the active oxygen level along said inner wall sufficiently high to suppress deposition of carbon on said inner wall.

12. The process of claim 11, wherein said membrane effuses sufficient active oxygen into said hot zone to maintain a carbon-to-oxygen atomic ratio of about 1:1 along said inner wall.

13. The process of claim 10 comprising adding CO₂ to said hydrocarbon feed.

14. The process of claim 10, wherein said membrane, or a section thereof, further comprises a carbon suppression catalyst that converts carbon to one or more carbon oxides to suppress carbon deposition on said inner wall when the reformer operate to produce synthesis gas.

15. The process of claim 10, wherein said reforming catalyst in said hot zone comprises:
at least one metal selected from the group consisting of Pt, Rh, Ir, W, Mo, Co, Fe, and alloys thereof, or
a metal oxide selected from the group consisting of hexaaluminates, cerates and perovskites.

16. The process of claim 10, wherein said membrane, or a section thereof, further comprises a carbon suppression catalyst which is the same or different than said reforming catalyst.

17. The process of claim 10 wherein said reforming catalyst in said hot zone comprises a metal oxide, and said membrane, or a section thereof, comprises a metal oxide that is the same or different than said reforming catalyst.

18. The process of claim 17 wherein at least one of said reforming catalyst and said membrane comprises:
(i) at least one metal oxide having the formula:
La₁₋ₓAₓBO_{3-δ}, wherein A=Ca²⁺ or Sr²⁺, B=Co, Mn, or Fe, wherein x is greater than 0 and less than 1, and δ is the number of oxygen vacancies in the resulting oxide crystal lattice, and
(ii) optionally, a refractory support.

19. The process of claim 18, wherein at least one said metal oxide has the formula La₁₋ₓSrₓFeO_{3-δ}, wherein x is greater than 0 and less than 1 and δ is the number of oxygen vacancies in the metal oxide crystal lattice, said metal oxide being disposed on a refractory support.

20. The process of claim 19, wherein the membrane, or a portion thereof, comprises La₁₋ₓCaₓFeO_{3-δ}, optionally deposited on a ceramic support, and the reforming catalyst comprises La₁₋ₓCaₓFeO_{3-δ} or Pt—Rh wire gauze.

21. The process of claim 10, wherein said refractory support comprises yttria stabilized zirconia.

22. An oxygen transport membrane for a fuel reforming reactor, comprising:
a structure having an inner surface; an outer surface; and a metal oxide material selected from the group consisting of hexaaluminates, cerates and perovskites, wherein said metal oxide material transports oxygen from said outer surface and effuses active oxygen at said inner surface, when an oxygen containing gas is passed over said outer surface; and
optionally, a carbon suppression catalyst deposited on said inner surface, wherein said carbon suppression catalyst converts carbon to carbon oxides in the presence of active oxygen.

23. The membrane of claim 22 wherein said metal oxide has the formula La₁₋ₓAₓBO_{3-δ}, wherein A=Ca²⁺ or Sr²⁺, B=Co, Mn, or Fe, x is greater than 0 and less than 1, and δ is the number of oxygen vacancies in the metal oxide crystal lattice.

24. The membrane of claim 23, wherein said membrane comprises a first section configured for surrounding a <900° C. zone in a fuel reforming reactor and a second section configured for surrounding a >900° C. zone in said reactor, wherein said first section provides a higher oxygen flux than said second section, when an oxygen containing gas is passed over said outer surface.
